(19) United States
(12) Patent Application Publication
(10) Pub. No.: US 2019/0338622 A1
(43) Pub. Date: Nov. 7, 2019

(54) MULTI-PERIOD AND DYNAMIC LONG TERM PLANNING OPTIMIZATION MODEL FOR A NETWORK OF GAS OIL SEPARATION PLANTS (GOSPS)

(71) Applicants: Saudi Arabian Oil Company, Dhahran (SA); UCL Business PLC, London (GB)

(72) Inventors: Ishaq Mohammed Alhasan, Dammam (SA); Songsong Liu, London (GB); Lazaros Papageorgiou, London (GB)

(21) Appl. No.: 16/399,667

(22) Filed: Apr. 30, 2019

(30) Foreign Application Priority Data
May 2, 2018 (GR) 20180100179

(51) Int. Cl. E21B 43/01; G06N 7/00

(52) U.S. Cl. CPC E21B 43/0107; G06N 7/00

(57) ABSTRACT

A mass balance is determined for periodic final inlet component flow rates entering Gas Oil Separation Plants (GOSPs). For transfers between GOSPs, constraints are calculated based on capacities of pipelines and a single direction of transfer. Calculated final inlet component flow rates are maintained for each GOSP within the calculated maximum and minimum GOSP pipeline capacities. Raw materials and intermediate and final states are formulated. Consumed power is calculated in in linear form using known flow rates per equipment. Investment decisions are performed with respect to swing pipelines and new equipment and a final net present value (NPV) is calculated with an overall objective function.

### CROSS REFERENCE TO RELATED APPLICATIONS

This application claims the benefit of priority to Greek International Patent Application Serial No. 20180100179, filed on May 2, 2018, and entitled “MULTI-PERIOD AND DYNAMIC LONG TERM PLANNING OPTIMIZATION MODEL FOR A NETWORK OF GAS OIL SEPARATION PLANTS (GOSPS).” The contents of which are hereby incorporated by reference.

### BACKGROUND

Upstream Gas Oil Separation Plants (GOSPs) are designed to handle production rates of associated hydrocarbon wells for a certain period of time. Beyond this period, it is necessary to upgrade GOSPs to account for planned future production rates, which can be considerably different than previous production rates.

### SUMMARY

The present disclosure describes long-term planning for Gas Oil Separation Plants (GOSPs).

In an implementation, a mass balance is determined for periodic final inlet component flow rates entering Gas Oil Separation Plants (GOSPs). For transfers between GOSPs, constraints are calculated based on capacities of pipelines and a single direction of transfer. Calculated final inlet component flow rates are maintained for each GOSP within the calculated maximum and minimum GOSP pipeline capacities. Raw materials and intermediate and final states are formulated. Consumed power is calculated in in linear form using known flow rates per equipment. Investment decisions are performed with respect to swing pipelines and new equipment and a final net present value (NPV) is calculated with an overall objective function.

Implementations of the described subject matter, including the previously described implementation, can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented in particular implementations, so as to realize one or more of the following advantages. First, the described methodology/model maximizes utilizations of an asset to target a minimal upgrade plan and optimize net present value. Second, the described methodology/model considers both operational expenditures and capital expenditures under a single objective to optimize a complicated network of GOSPs as a single node. Both real-time production and long-term planning are optimized. Third, finding an optimum plan to upgrade an integrated network of facilities for future production rates is very complicated and requires through evaluation and careful consideration of thousands of variables. The current practice considers individual GOSPs upgrade plans with no/minimal integration with an entire network. This doesn't necessarily provide an optimum solution for maximizing utilization of assets as a single network, but the described methodology/model ensures that the proposed solution is optimal and ensures maintenance of all rotating equipment within the network with respect to a best mode of operation.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

This patent or application file contains at least one color drawing executed in color. Copies of this patent application publication with color drawings(s) will be provided by the Patent and Trademark Office upon request and payment of the necessary fee.

FIG. 1 is a diagram illustrating common prior art optimization boundaries in upstream real-time problems related to surface facilities, according to an implementation of the present disclosure.

FIG. 2 is a diagram illustrating a target optimization boundary in upstream real-time problems related to surface facilities, according to an implementation of the present disclosure.

FIG. 3 is an illustration of an example gas-oil separation plant (GOSP) and associated hydrocarbon wells, according to an implementation of the present disclosure.

FIG. 4 is a diagram illustrating example inputs and outputs of a GOSP, according to an implementation of the present disclosure.

FIG. 5 illustrates a process flow for a GOSP, according to an implementation of the present disclosure.

FIGS. 6A-6C illustrate example flow vs. power curves, according to an implementation of the current disclosure.

FIG. 7 is a diagram illustrating an example network of GOSPs connected laterally by swing pipelines, according to an implementation of the present disclosure.

FIG. 8 is a graph illustrating a comparison of convergence curves between Gurobi and Cplex solvers using two different computing machines, according to an implementation of the present disclosure.

FIG. 9 illustrates a comparison of net present value (NPV) for previously-mentioned modes associated with FIG. 8 and a non-optimized mode “current practice,” according to an implementation of the current disclosure.

FIG. 10 is a diagram illustrating yearly transfers and investment decisions for an entire forecast period, according to an implementation of the present disclosure.

FIG. 11A-11B are flowcharts illustrating an example of a computer-implemented method for long-term planning for GOSPs, according to an implementation of the present disclosure.

FIG. 12 is a block diagram illustrating an example of a computer-implemented system used to provide computational functionalities associated with described algorithms, methods, functions, processes, flows, and procedures, according to an implementation of the present disclosure.

FIG. 13 illustrates a flow chart as an STN directed graph, according to an implementation of the present disclosure.

Like reference numbers and designations in the various drawings indicate like elements.

### DETAILED DESCRIPTION

The following detailed description describes long-term planning for Gas Oil Separation Plants (GOSPs), and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

The petroleum industry has a large effect on the global economy and is a leader in technology development and enhancement. Optimization literature for the petroleum industry covers a wide range of subjects from strategic planning to short term allocation problems. Given the maturity of the industry, applications of mathematical programming have been employed for decades, but have been given little attention, possibly due to the unconventional nature of the project as surface facilities usually stand alone with no connections or integration with nearby similarly-purposed facilities.

The petroleum industry is usually divided into four major sectors forming a “value chain”: 1) exploration; 2) upstream (or exploration and production); 3) midstream; and 4) downstream. Exploration covers initial seismic studies and drilling to explore oil reserves before developing the field and commencing production. Upstream includes searching for potential underground or underwater hydrocarbon fields (for example, crude oil and natural gas), drilling exploratory wells, and subsequently drilling and operating the wells that recover and bring hydrocarbons to the surface. Upstream also includes all facilities for production and preliminarily treatment and stabilization from the wellheads to the intersection with midstream. It is also sub-characterized to surface and subsurface facilities. As the name implies, the surface facilities cover GOSPs, while the subsurface covers the drilling and wells operation. Midstream generally covers gas treatment processes, liquefied natural gas (LNG) operations, and oil/gas transportation pipelines between the upstream and downstream. Downstream mainly refers to refineries and storage facilities where oil, gas and condensates are processed to marketable products and then shipped to end users. The focus of this disclosure is on optimization related to hydrocarbon production through surface separation facilities, which is an upstream activity.

Several frameworks have been proposed to divide planning of upstream optimization problems according to particular activities and time scales. Production optimization is then based on the proposed activities and timescales. For example, real-time production optimization (RTPO) is defined as a steady-state constrained model developed to recalculate optimum values of set points on a regular basis in response to any change in parameters (for example, supply flow rates and demands). RTPO is considered by far the most widely-used optimization technique in the petroleum industry.

Another grouping, based on scope and function classifies optimization problems in an upstream sector into: 1) Lift gas and production rate allocation; 2) Optimization of upstream production system design and operations; and 3) Optimization of reservoir development and planning. Optimization of surface separation facilities are rarely reported individually and usually covered within generalized production models. Interest areas (that is, real-time production optimization and long-term planning optimization) are considered in 1) and 2), respectively.

Lift Gas and Production Rate Allocation

Lift gas operations are very common in the oil industry and considered one of the least expensive options to boost up reservoir pressure and ultimately enhance oil production and recovery from an oil reservoir. Optimization in this area is focused on finding an optimal balance, during an operational phase, between gas injection in the reservoir and oil production based on a gas-lift performance curve, mainly to maximize oil production. Water is sometimes used instead of gas, not to initiate a lift operation but to enhance oil production by increasing the pressure of the reservoir. In all proposed models for lift gas operations, surface facilities are treated as constrained parameters in terms of capacity limitation of gas, oil and water. The operational expenditures (OPEX) of the surface facilities are usually neglected in the traditional gas or water injection optimization models, due to the assumption that the value of oil production increases will always outweigh any optimization in the OPEX; therefore, it is always preferable to maximize oil production regardless of the surface facility OPEX. This is true only if oil and gas prices are maintained above a certain value. If oil/gas market prices sharply drop, then this assumption is no longer valid.

In some instances surface facility OPEX is considered in an objective function of models, where the objective function is modified to maximize net present value (NPV) rather than maximizing only oil production. An example of such objective function is parts of a total system production optimization model for a complex off-shore production operation. The model considers combined performance of the total system including well configuration, gas rate allocation, production gathering distribution and surface facility OPEX; including compressors and pumps. The model resulted in a 3% total production increase, a 4% reduction in lift gas requirements and a 3% decline in operating costs. Another proposed nonlinear programming (NLP) model maximizes the NPV for a single wells-facility configuration. The OPEX of the surface facility considered in the objective function is assumed to be constant for the separation process and only variable for the gas compressing station by fitting a gas compressor flow vs. power curve into the model. Another example couples a surface model for oil production and water injection facilities with subsurface simulation model to optimize overall production strategy and cost. The model used for the surface facility was developed to be coupled with an in-house reservoir simulator to optimize the NPV.

There is a lack of consideration for real-time production optimization of a network of surface separation facilities laterally. As far as surface facility OPEX is concerned, all known optimizations treat single production trains without any integration with other production trains. The priority in such models is driven towards maximizing oil production. As a result, the OPEX of the surface facility is either neglected or over-simplified.

There is also limited consideration of single surface facility OPEX optimization without considering maximization of oil production. One example is of a mixed integer nonlinear programming (MINLP) model used to optimize power consumption of a gas station consisting of 5 compressors by allowing the compressors to have unequal loads rather than the traditional approach of load sharing for running equipment in the same set. The model is claimed to result in a considerable power saving for certain flow rates.

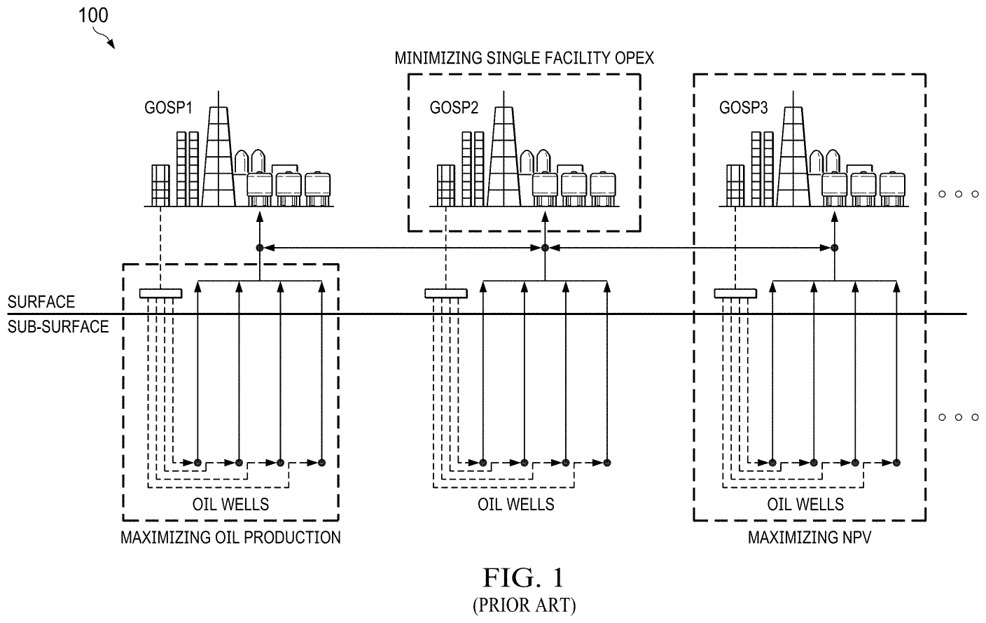

Turning to FIG. 1, FIG. 1 is a diagram 100 illustrating common prior art optimization boundaries in upstream real-time problems related to surface facilities, according to an implementation of the present disclosure. The objective of the associated models is either: 1) maximizing oil production; or 2) minimizing single facility OPEX or maximizing NPV. None of the models consider multiple production trains in a single model to optimize combined OPEX.

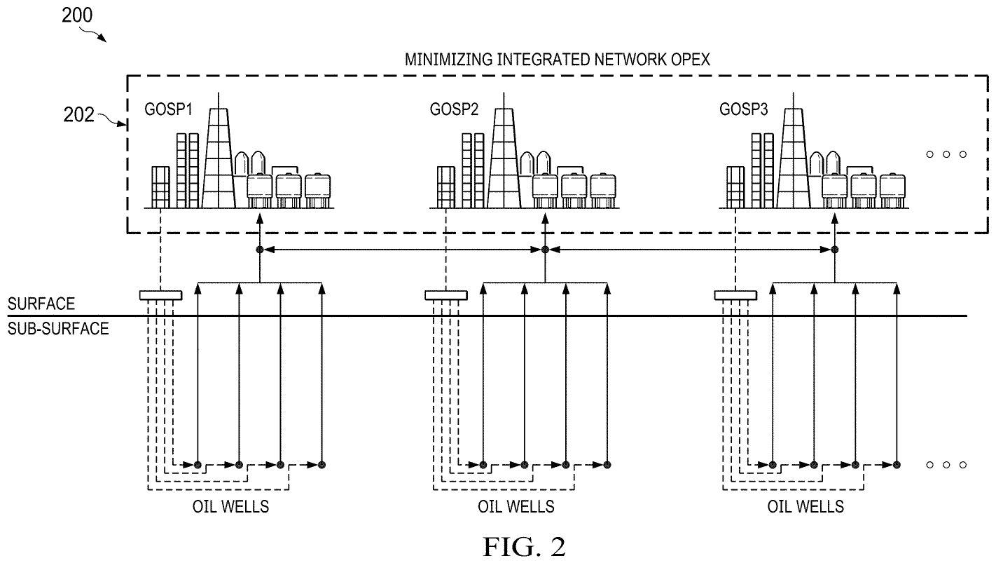

Turning to FIG. 2, FIG. 2 is a diagram 200 illustrating a target optimization boundary in upstream real-time problems related to surface facilities, according to an implementation of the present disclosure. The targeted optimization boundary minimizes integrated network OPEX and does not overlap with existing models or pose any constraints. On the contrary, the described optimization could be applied sequentially post-optimization by any existing optimization boundary model in a complementary manner.

Optimization of Upstream Production System Design and Operations

The planning and design of oil and gas field development projects is very important because corresponding investment decisions are effectively irreversible and huge financial resources are committed over a long time period. With planning comes design optimization which is necessary to ensure optimality for the long term, based on available forecasts. Optimization decisions in this group usually cover: 1) field selection; 2) well placement; 3) pipeline development; 4) surface facility construction; 5) production planning; and 6) complete transmission planning.

Nodal analysis, has been the traditional method to optimize production system design and operation. This is achieved by fixing all parameters and allowing only a single variable to vary, until the optimum objective function is obtained. Formal optimization algorithms are needed in such applications. A newton-type optimization algorithm is applied to optimize tubing diameter and separator pressure of a single well system. The model has demonstrated the usefulness of multivariate optimization techniques.

Afterwards, industrial practice took a silo approach when optimizing upstream production facility design and planning due to computational challenges of modelling the whole network. Reservoir, wells and pipeline networks are usually optimized as a single node and surface facilities as another, where an inlet separator in the surface facility acts, in most cases, as a dividing wall between the two segments. In the reservoir, wells and pipeline network optimization models, the surface facility is either neglected or represented within the model with great simplicity by considering fixed and variable costs based on production rates.

For detailed optimization of surface facility development cost, commercial optimizers such as NETOPT is used and combines a general multiphase network simulator with a sequential quadratic programming (SQP) algorithm to maximize oil production from the surface facility while minimizing operating costs. For example, NETOPT can be applied to a gas station application to optimize capital and operating costs of a compressor unit required to meet the forecasted production rates of a gas field.

Segregation of upstream areas in optimization models may lose further optimization opportunities when combined. The two areas affect each other and undermine overall segregated optimization achieved. For example, gas, water, or gas and water rate separated in the surface facility is re-injected back into the reservoir to enhance oil recovery, and part of it will come out with the produced crude to the surface facility. Therefore, an integration of the two models in a single closed loop adds an obvious potential, rather than optimizing the two models independently in two open loops.

For this reason, several attempts have taken place to couple a subsurface model with a surface model for the purpose of design optimization. Early attempts to couple and integrate two models included an integrated application for reservoir production strategies and field development management that coupling a reservoir simulator ECLIPSE with a surface facility optimizer NETOPT. Other approaches included coupling an ECLIPSE reservoir simulator to a gas surface deliverability forecasting model FORGAS and an integrated development model to analyze production-injection operation systems (PIOS) by coupling four different simulation models: 1) reservoir; 2) injection; 3) production; and 4) surface facilities, and then to use the values in an economic optimization model with an objective function to maximize the NPV (extending the reservoir life at minimized NPV). Another example includes modeling a common field asset from reservoir to surface facility by integrating detailed simulation models for each area. For the surface facility model, the process is represented by simulation through the HYSYS process simulator. This representation provided a complete composition analysis and physical property profile for streams. Data was fed into an economic model to calculate the OPEX and minimize the NPV objective function. Still another example includes an integrated model for making a group of strategic decisions about oil and gas development projects simultaneously over a long term planning horizon. The surface facility is modelled briefly by only considering fixed and variable costs proportional to the production flow rates.

There is a lack of consideration for optimization of a network of surface facilities at lateral level to optimize design decisions and OPEX. Single surface facility design optimizations are often carried out by utilizing commercial optimizers, and when considered in integrated models are usually oversimplified to avoid computational challenges arising from modelling huge networks.

Synthesis of Process Systems

Over the past few decades, there has been significant advancement and attention towards the synthesis of process systems. Literature provides generous data in terms of modes of operations (for example, continuous, batch, or semi-continuous), where the discretion of time plays a vital rule in the modelling. The literature has also covered multi-product and multi-purpose process plants where different products may be manufactured through the same or different sequence of operations sharing the same equipment, intermediate materials, and other resources. This has given rise to specialized models, such as sequencing and scheduling problems, where the former dictates the number of batches of different products that need to be manufactured to fulfil production demands. On the other hand, sequencing determines precise timing of each batch of material going through the system. The production time span is also considered (whether short, medium, or long term). Modules for any combinations have been developed and refined periodically to tackle a wide-range of process systems problems.

There are three major steps for the mathematical programming approach of process synthesis: 1) developing all alternative presentations of which the optimal solution is selected; 2) formulating a mathematical program that generally involves discrete and continuous variables for the selection of operations levels and configurations. Mixed integer linear programming (MILP) is the most widely used for process synthesis problems due to its rigorousness, flexibility, and extensive modelling capability, and 3) solving the mathematical model to optimize the problem. The first step is considered of huge importance and requires a thorough knowledge of the process and operation. However, there are two challenges that usually arise when postulating a superstructure of alternatives. The first is identifying all major representations for given alternatives and their implications on the model. The second is identifying all alternatives for a given representation to ensure that the optimal solution isn't overlooked. Two major types of representations are: 1) state task network (STN) and 2) state equipment network (SEN).

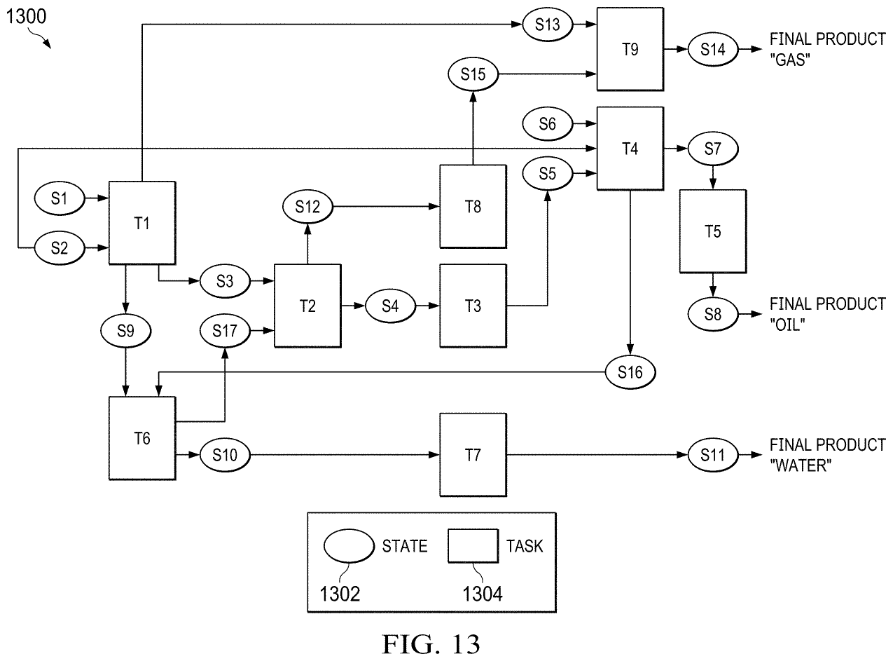

FIG. 13 illustrates a flow chart as an STN directed graph 1300, according to an implementation of the present disclosure. STN forms a directed graph with two types of distinctive nodes: 1) state nodes 1302 representing raw materials, intermediate, and final products and 2) task nodes 1304 representing physical or chemical operations. For each GOSP, a process is modeled (for example, as in FIG. 13) using the STN approach. The assignment of equipment is dealt implicitly in the model. With such representation, both options of one task one equipment (OTOE) and variable task equipment (VTE) can be assigned and considered. STN can be extended to a resource task network (RTN) framework which considers the entire characterizations of resources including materials, equipment, storage, and utilities. Each task transforms a set of resources to another set of resources.

Table 1 illustrates data associated with an STN flow chart (for example, as in FIG. 13):

TABLE 1
STN Flow Chart Associated Data

| State | | | | Task | |
|---|---|---|---|---|---|
| S1 | Crude feed | S10 | Water | T1 | Three Phase |
| | | | separated | | (Gas/Oil/Water) |
| | | | from T6 | | High Pressure |
| | | | | | Separation |
| S2 | Chemicals | S11 | Final | T2 | Two Phase |
| | injection | | Product | | (Gas/Oil) |
| | | | “Water” | | Low Pressure |
| | | | pumped by | | Separation |
| | | | T7 | | |
| S3 | Oil | S12 | Gas | T3 | Two Phase |
| | separated | | separated | | (Oil/Water) |
| | from T1 plus | | from T2 | | Pumping |
| | remaining | | | | |
| | gas and | | | | |
| | water | | | | |
| S4 | Oil | S13 | Gas | T4 | Two Phase |
| | separated | | separated | | (Oil/Water) |
| | from T2 plus | | from T1 | | Dehydration + |
| | remaining | | | | Desalting |
| | water | | | | |
| S5 | Oil & | S14 | Final | T5 | Oil Product |
| | remaining | | Product | | Pumping |
| | water | | “Gas” | | |
| | pumped by | | compressed | | |
| | T4 | | by T9 | | |
| S6 | Fresh water | S15 | Gas | T6 | Two Phase |
| | injection | | Compressed | | (Water/Oil) |
| | | | from T8 | | Low Pressure |
| | | | | | Separation |
| S7 | Oil | S16 | Water | T7 | Water Product |
| | separated | | separated | | Pumping |
| | from T4 | | from T4 | | |
| S8 | Final | S17 | Oil | T8 | Low Pressure |
| | Product | | separated | | Gas |
| | “Oil” | | from T6 | | Compression |
| | pumped by | | | | |
| | T5 | | | | |
| S9 | Water | | | T9 | High Pressure |
| | separated | | | | Gas |
| | from T1 and | | | | Compression |
| | emulsified | | | | |
| | oil | | | | |

SEN is similar in concept to STN, but a task node in STN is replaced by equipment nodes in the SEN. The tasks in the SEN are allocated in the model.

The decision of which representation to select depends on compatibility between a process and the representation's methodologies. The representation of the process can either be aggregated, short-cut, or rigorous models depending on the complexity and details included. Adding too much detail can result in computational challenges and rigidness to find an optimal solution. On the other hand, simplifying a flow sheet can result in overlooking critical details that can render a model impractical. Therefore, a process flow sheet representation must be programmed based on a comprehensive understanding of the process and the capabilities of mathematical programming.

Upstream GOSPs are designed to handle production rates of associated hydrocarbon wells for a certain period of time. Beyond this period, it is necessary to upgrade GOSPs to account for planned future production rates, which can be considerably different than previous production rates.

The difficulty is determining an optimum long-term upgrade plan describing when to upgrade particular GOSPs within a network of GOSPs. Finding the optimum plan to upgrade an integrated network of facilities for future production rates is very complicated and requires through evaluation and careful consideration of thousands of variables.

The disclosure describes a long-term planning model that can generate an optimum long term upgrade plan for a network of GOSPs. Individual GOSP's upgrade plans are considered with no or minimal integration within an entire GOSP network. This doesn't necessarily provide the optimum solution for maximizing the utilization of assets as a single network. However, the long-term planning model can ensure that a proposed solution is optimum. The objective of the long-term planning model is to maximize use of existing assets and to minimize additional equipment, pipelines, and shut downs (S/Ds) in response to a forecasted production plan (for example, covering 20 years).

At a high-level, an entire GOSP network is considered as a single node rather than as individual plants to upgrade. Using connections between particular facilities and associated spare capacities, the long-term planning model targets maximum utilization of assets and can propose an optimum upgrade plan for a required future production period. The proposed long-term planning model is a MILP model that covers long-term planning decisions for a multi-period forecast of an existing GOSPs network. The decisions can include, among other things:
Upgrading component capacity of GOSPs by adding additional equipment as required. The added equipment is identical in terms of, for example: capacity, head, flow rate, and power consumption to existing parallel equipment in a task to avoid any disturbances to the systems if different characteristic equipment is added,
Installing new swing pipelines between any two GOSPs to allow transfers. The capacity of the swing pipelines are predetermined based on maximum well deliverability without the need for artificial boosting to maintain natural free flow, and
Time periods for these investment decisions.

The proposed long-term planning model is mathematically-rigid and can ensure that an optimal upgrade plan is selected. Even if conventional practices are followed, the proposed model can be used to validate and compliment a selected plan.

Integration of GOSPs production laterally opens the door for an unexplored optimization frame. The current practice in the upstream of single production trains' optimizations when considering surface facilities' operational expenditures (OPEX) to always tend to maximize oil production, since the added value to an objective function is higher. Therefore, room for optimizing OPEX is overshadowed by benefits of oil production maximization; hence OPEX optimization, if achieved, is very limited.

The instant disclosure frees surface facilities' OPEX from restrictions in oil maximization objectives by exploring a different optimization frame that comes after real-time oil well production optimization. This is achieved by integrating GOSPs' wells production at the surface facilities among them. The long term planning of these GOSPs is then considered by developing a dynamic, multi-period, long-term planning MILP model for optimum integration and investment decisions based on a planned production forecast.

The described long-term planning model maximizes utilizations of current assets to target a minimal upgrade plan and, therefore, an optimum Net present value. The uniqueness of the described long-term planning model is that it considers both OPEX and capital expenditures (CAPEX) under a single objective to optimize a complicated network of a GOSPs as a single node. Therefore, both real-time production and long-term planning is optimized.

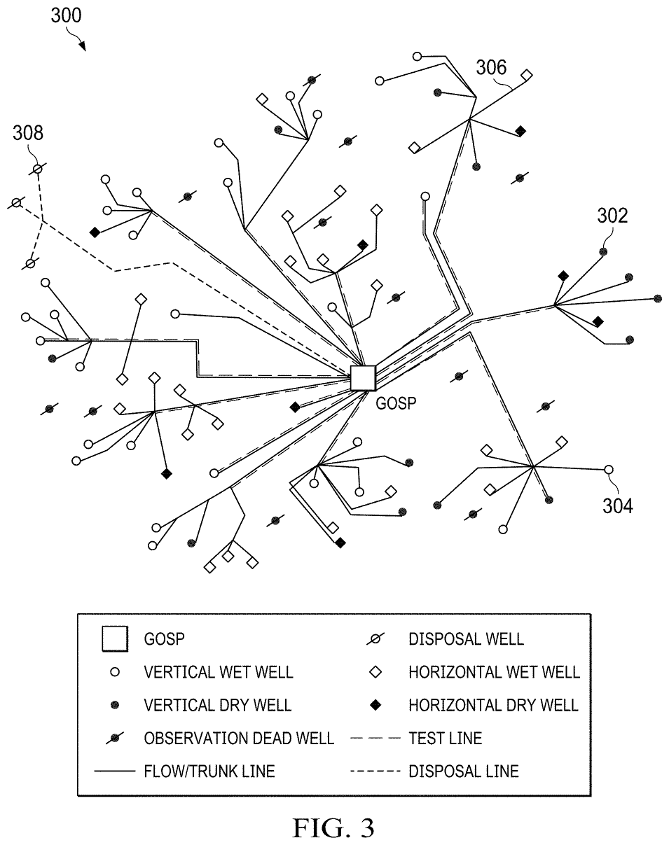

Turning to FIG. 3, FIG. 3 is an illustration of an example gas-oil separation plant (GOSP) 300 and associated hydrocarbon wells, according to an implementation of the present disclosure. In the upstream oil and gas industry, a surface separation facility is called a GOSP. Every GOSP receives its input (that is, feed) from several hydrocarbon wells located municipally around the GOSP. Some of these wells are dry (for example, vertical dry well 302) and some are wet (that is, contains associated water), such as vertical wet well 304. FIG. 3 illustrates a holistic view of a complete single upstream field where the GOSP 300 is located in the middle and hydrocarbon wells are connected to the GOSP 300 through pipelines (for example, flow/trunk line 306). The GOSP 300 can also be connected to disposal wells (for example, disposal well 308) which receive treated gas, water, or gas and water from the GOSP 300 to boost reservoir pressure and enhance oil production and sweep in the subject area.

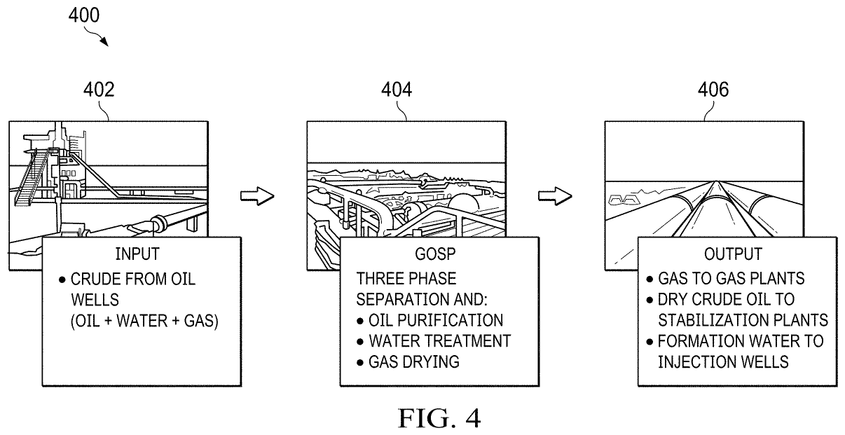

FIG. 4 is a diagram 400 illustrating example inputs and outputs of a GOSP, according to an implementation of the present disclosure. A GOSP 404 (for example GOSP 300 of FIG. 3 receives input 402 (such as, crude from oil wells). The GOSP 404 performs a three-phase separation and: 1) oil purification; 2) water treatment; and 3) gas drying. The GOSP 404 then outputs 406 results of its operations (such as, gas to gas plants, dry crude oil to stabilization plants, and formation water to injection wells).

A GOSP is considered as a first crude treatment process to provide preliminary separation of crude to oil, gas, and water. Its objective is primarily to separate gas, water, and contaminants from the crude and treat the three products to required specifications. Then, oil and gas are streamed to oil refineries and gas processing plants respectively for further processing. Water and sometimes part of the gas is injected back in a reservoir, depending on the oil recovery enhancement strategy of the hydrocarbon production field.

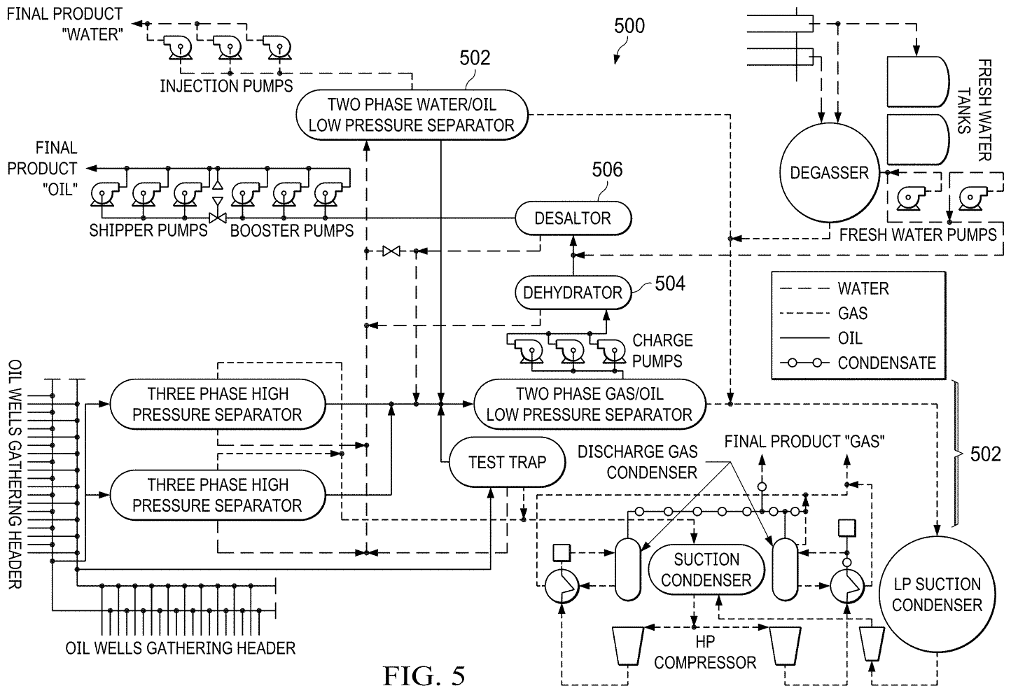

Turning to FIG. 5, FIG. 5 illustrates a process flow 500 for a GOSP, according to an implementation of the present disclosure. Illustrated are main process units and equipment. Utility systems are not illustrated in FIG. 5, as they are not part of the actual process but provide energy, water, air, or some other utility to the GOSP. Primary operations within a GOSP can be summarized as: 1) separation 502—separating the gas, oil and water from produced wellhead streams through multiple tasks; 2) dehydration 504—removing water droplets emulsified within the oil; and 3) desalting 506—reducing the salt content of the crude by diluting associated water and then dehydrating.

GOSP OPEX

OPEX of the upstream has been consistently trending upwards over the past few years, and unlikely to swing downwards. GOSPs are considered to be the main consumer of OPEX in the upstream (when considering exploration as a separate sector). This is particularly true if the field production from wells is naturally flowing without any artificial lift requirements.

The GOSPs' OPEX can be classified to four main groups: 1) manpower costs; 2) maintenance/service costs; 3) chemical consumption costs; and 4) power consumption costs. For the purposes of the describe methodology, the first two are not considered. The latter two are purely operational and the subject of optimization by minimization.

Chemicals Consumption Costs

Beside crude received from hydrocarbon wells, GOSPs consume chemicals as raw materials for different purposes. For example, primary chemicals consumed are:
1. Demulsifiers—chemical substances used to enhance separation between oil and water in highly emulsified mixtures. As emulsion increases in a mixture, a required demulsifier injection rate increases as well. Hence, it is a function of the mixture flow rate and an associated emulsion index. A major factor affecting emulsion formation is GOSP design and an amount of agitation added to the transported fluid from hydrocarbon wells to the separates. Therefore, every GOSP uses a different demulsifier type that is prepared experimentally from a mixture of chemical substances to suit a particular emulsion index of the GOSP and to maximise separation efficiency. Accordingly, a consumption rate of demulsifier and unit costs are also different,
2. Corrosion inhibitor—primarily to prevent corrosion development in metal pipelines, and
3. Scale inhibitor—to prevent any scale build-up in containers.

Power Consumption Costs

GOSPs' sizes/output levels vary greatly (for example, from approximately 20 thousand barrels per day (MBD) to 400 MBD of oil). The size of a GOSP is determined by forecasted production rates for associated field wells. A standard GOSP size for the purposes of this disclosure is around 330 MBD. These facilities require an intensive power supply to run the various rotating equipment contained. In some implementations, the major sets of power equipment can include: 1) charge pumps (for example, two phase pumps, oil and water); 2) injection pumps (for example, water); 3) boosting pumps (for example, oil); 4) shipper pumps (for example, oil); 5) high-pressure compressors (for example, gas); and 6) low-pressure compressors (for example, gas). Every GOSP has the same set of equipment, but vary greatly with respect to capacity, efficiency, and a number of equipment depending on age, design parameters, and philosophy.

Equipment draws power as a function of load (that is, a processed flow rate). Manufacturers and equipment designers conveniently represent the flow vs. power relationship in characteristic curves. These curves are developed experimentally during a manufacturing stage and tuned to suit particular applications as required by clients in order to maintain power consumption for every unit of equipment at optimal points, based on a most prevalent production rates' window while meeting required heads. Some factors that greatly affect this relationship are fluid properties, rotational speed, impeller diameters, and a number of impellers and materials of construction. Unless GOSPs are identical and built at the same time, it is very likely that a flow vs. power relationship for the same equipment sets is different from one GOSP to another.

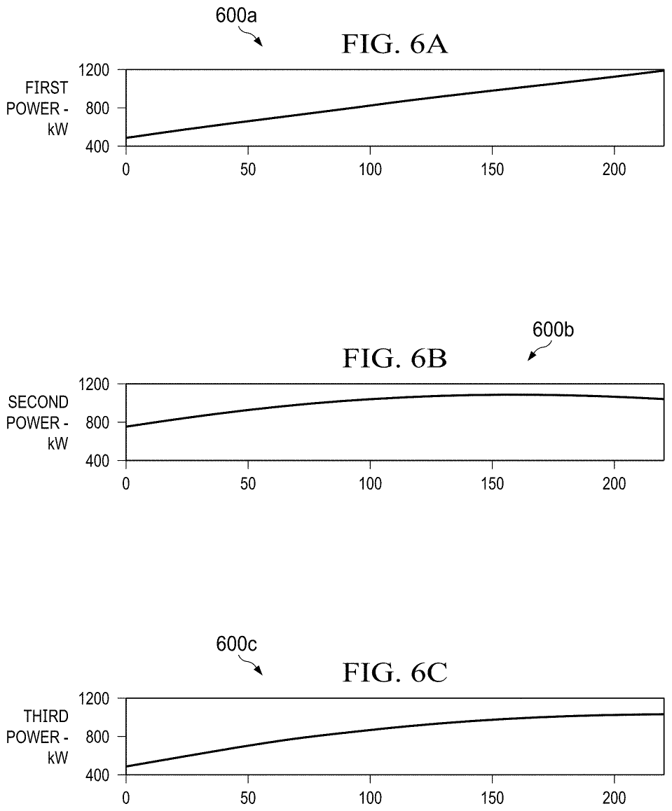

FIGS. 6A-6C illustrate example flow vs. power curves 600a-600c, according to an implementation of the current disclosure. FIGS. 6A-6C represent examples of three shipper pumps' flow vs. power curves used in example GOSPs. In FIGS. 6A-6C, the vertical axis represents power in kilowatts (kW) and the horizontal axis represents a flow rate in MBD. As illustrated, a corresponding power requirement for similar flow rates differs from one application to another. For example, in FIGS. 6A-6C, at a 100 MBD flow, corresponding power from the three curves is approximately 800 kW (FIG. 6A), 1000 kW (FIG. 6B), and 900 kW (FIG. 6C) for the 1^{st}, 2^{nd} and 3^{rd} pump, respectively. For this reason, choosing the right equipment for certain rates or choosing the right operating point to maximize efficiency of power consumption could result in a considerable savings for an operator. For instance, a 100 MBD flow could be processed by the 1st pump for a lower power consumption than the other two pumps. Also, a 200 MBD flow requires lower power to process for the 2^{nd} pump than 150 MBD for the 1^{st} and 3^{rd} pumps.

Network of GOSPs

In rich hydrocarbon reserve areas, such as Gulf Coast countries (GCC), large number of GOSPs exists near each other within the same geological area to serve high-demands of production. Typically, hydrocarbon wells serve only one GOSP due to the high cost of pipelines that would be required to connect the wells to more than one GOSP. Some of these GOSPs are connected together laterally through swing pipelines, which allow the transfer of a GOSP's well production to be treated in another GOSP. The purpose of these swing pipelines is to provide a backup route of production from all wells in case of any breakdown or during planned or unplanned shutdown of a GOSP to avoid any intermittent production. These pipelines are constructed only between nearby GOSPs where wells can flow naturally. For distant connections, surface multiphase pumps or subsurface electrical submersible pumps (ESP) may be used to transfer the wells' production to other GOSPs.

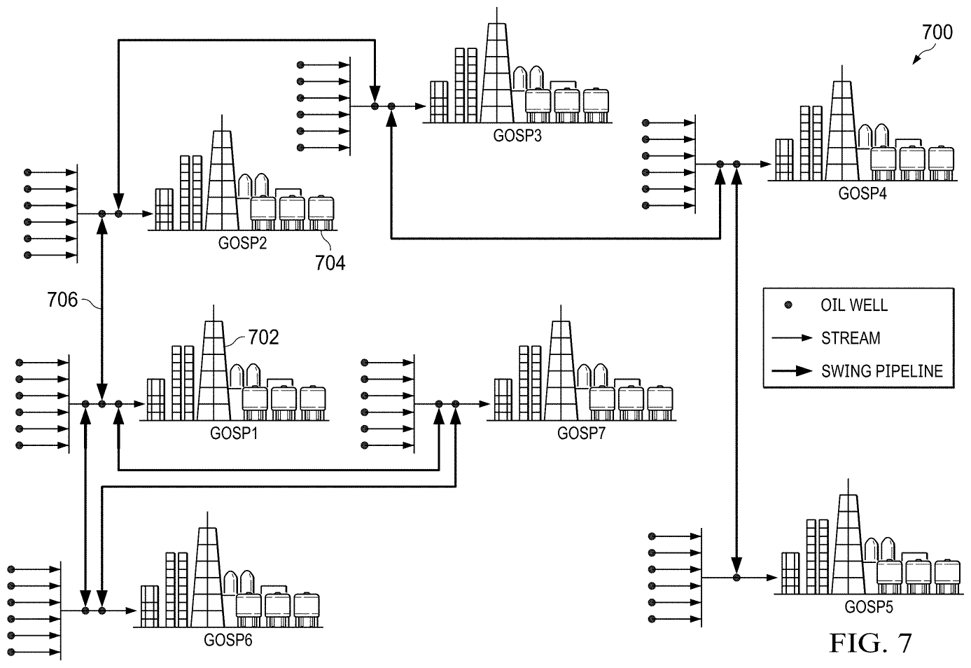

Turning to FIG. 7, FIG. 7 is a diagram illustrating an example network 700 of GOSPs connected laterally by swing pipelines, according to an implementation of the present disclosure. For example GOSP1 702 and GOSP2 704 are connected by swing pipeline 706. The production from the wells of a GOSP can be produced through the same GOSP or diverted partially/completely to one of the connected GOSPs for processing. It is worth noting that the existence of the swing pipelines is rare and only found in a few applications. However, consideration of the swing pipelines for new projects is increasing due to their added flexibility and tangible benefits in many aspects.

At a high-level, the disclosure describes a methodology of long-term planning for Gas Oil Separation Plants (GOSPs). In particular, the described methodology is for optimizing long-term planning for an existing network of GOSPs by developing a multi-period and strategic-investment decision model, based on a long-term production forecast. The described model covers integrated OPEX and CAPEX in an objective function so that optimum combined costs can be achieved while minimizing required upgrades in response to the long-term production forecast.

In some implementations, input data includes:
GOSPs process flow sheets,
Total GOSP design capacities per component and bottlenecks,
Chemicals consumption rates as functions of the processed rates and GOSPs circumstances and parameters,
Chemicals market price for each GOSP,
Equipment number, minimum and maximum capacities,
Equipment heads, efficiencies and power consumption curves,
Transfer pipelines network connections and availability between GOSPs and their logistics,
Equipment operating modes based on the downstream conditions,
Components' separation fractions in the process units,
Power market price,
Potential capital upgrade projects for swing pipelines and equipment,
Cost estimates for potential CAPEX and their associated installation, maintenance/inspection, depreciation, and
Short and long term production forecast.

In some implementations, key variables to be optimized include:
Required Investment in terms of type, cost and time,
GOSPs selection,
Transfer pipelines selection (existing and new),
Quantities of transferred flow rates through swing pipelines,
Final inlet crude flow rates of each component, and
Equipment selection/upgrade and operating points (existing and new).

MILP Long-Term Planning Model for a Network of GOSPs

GOSPs are designed to account for forecasted production rates of a limited period of time (for example, a maximum of 10 or 20). Beyond this period, or if the forecast changes considerably, long-term planning of the GOSPs may require a thorough review to account for the new forecast. Described is a MILP model that covers long-term planning decisions for a multi-period forecast of existing GOSPs network. In some implementations, these decisions can include:
Upgrading the component capacity of the GOSPs by adding additional equipment. The added equipment is identical in terms of capacity, head, flow rate, and power consumption with respect to existing parallel equipment in a task to avoid any disturbances to the systems if equipment with different characteristics is added,
Installing a new swing pipeline between any two GOSPs to allow transfers. The capacity of the swing pipelines are predetermined based on the maximum well deliverability, without a need for artificial boosting so natural free flow can be maintained, and
Time period for investment decisions.

Table 2 provides details of MILP long-term planning model notations. The notations include indices, sets, parameters, scalars, binary variables, SOS2 variables, and continuous variables.

TABLE 2
MILP Long Term Planning Model’s Notations
INDICES

| | |
|---|---|
| g, g′ | Gas oil separation plant, GOSP |
| c | Component |
| j | Operating equipment/unit |
| i | Processing task |
| s | Produced and consumed states |
| k | Unit operating region |
| t, t′ | Time periods |

SETS

| | |
|---|---|
| G | Set of GOSPs |
| C | Set of crude components |
| J | Set of rotating equipment/unit (existing and potential) |
| I | Set of processing tasks |
| S | Set of produced and consumed states |
| T | Set of years |
| SR | Subset of S - raw materials |
| SP | Subset of S - products |
| SIN | Subset of S - intermediates |
| JP | Subset of J - pumps (existing and potential) |
| JC | Subset of J - compressors (existing and potential) |
| IROT | Subset of I that require tasks by rotating equipment (pumps + compressors) |
| IP | Subset of I that require tasks only by pumps |
| IC | Subset of I that require tasks only by compressors |
| Sᵢ | Set of states which are produced or consumed by task i |
| Iⱼ | Set of units which perform task i (existing and potential) |
| INewⱼ | Set of units which perform task i (potential equipment only) |
| Net_{g} | Set of connected GOSPs through swing pipelines (existing and potential) |
| NetNew_{g} | Set of connected GOSPs through swing pipelines (potential only) |

PARAMETERS

| | |
|---|---|
| PIC_{gg′} | Present installation cost between g and g′ for every potential swing pipeline |
| EIC_{gj} | Present installation cost for every potential j in g |
| DepEq_{gj} | Yearly depreciated capital value for every potential j in g |
| DepPi_{gg′} | Yearly depreciated capital value for every potential swing pipeline |
| MaintEq_{gj} | Yearly maintenance and inspection cost for every potential j in g |
| MaintPi_{gg′} | Yearly maintenance and inspection cost for every potential swing pipeline |
| fi_{tgc} | Initial designated component rate for g and t |
| RjMax_{gj} | Maximum capacity rate for j in g |
| RjMin_{gj} | Minimum capacity rate for j in g |
| MeffP_{gj} | Motor efficiency for every j ϵ JP in g |
| MeffC_{gj} | Motor efficiency for every j ϵ JC in g |
| GBeffC_{gj} | Gearbox efficiency for every j ϵ JC in g |
| ChemCoeff_{g} | Chemicals consumption coefficient for g |
| Temp_{tg} | Crude inlet temperature for g in t |
| SalF_{g} | Salinity coefficient for g |
| ChemCOST_{g} | Present chemicals market price for g |
| GMax_{gc} | Maximum upgraded component capacity for g (taking into account all GOSP potential upgrades) |
| GMin_{gc} | Minimum upgraded component capacity for g (taking into account all GOSP potential upgrades) |
| TPCMax_{gg′} | Maximum swing pipeline capacity between g and g′ (existing and potential) |
| TPCMin_{gg′} | Minimum swing pipeline capacity between g and g′ (existing and potential) |
| PSIprod_{gsic} | Fraction of components in each produced s for i at g |
| PSIcons_{gsic} | Fraction of components in each consumed s for i at g |
| CompFrac_{tcg} | Component fraction in the initial total flow rate for g in t |
| fiTot_{tg} | Total initial designated flow rate for g in t |
| Rjk_{gik} | Operating rates breakpoints for task i in g [piecewise linearisation] (existing and potential) |
| Pjk_{gik} | Power breakpoints for task i in g [piecewise linearisation] (existing and potential) |
| FOC_{g} | Present fixed operating costs for each g - Yearly |
| ICMaxₜ | Maximum yearly investment cost |
| dr | Discount rate |

SCALARS

| | |
|---|---|
| KwPrice | Power market price in [$ per kilowatt hours (kWh)] |
| OperTime | Operating hours [h] |
| M1 | Upper bound, more than maximum equipment flow rate |
| M2 | Upper bound, more than maximum equipment power consumption |

BINARY VARIABLES

| | |
|---|---|
| Ytpc_{tgg′} | 1 if transfer from g to g′ is selected; 0 otherwise; for t (existing & potential swing pipelines) |
| YtpcNEW_{tgg′} | 1 if a new swing pipeline from g to g′ is selected; 0 otherwise; for t (potential swing pipelines only) |
| Ygosp_{tg} | 1 if GOSP g is selected to process production rates; 0 otherwise |
| Yunit_{tgij} | 1 if unit j is selected to perform task i at g; 0 otherwise; for t (existing and potential equipment) |
| YunitNEW_{tgij} | 1 if unit j is selected to be installed to perform task i at g; 0 otherwise; for t (potential equipment only) |

SOS2 VARIABLE

| | |
|---|---|
| Yjk_{tgik} | For determining operating points within operating regions k for i at g in t [piecewise linearization] |

CONTINUOUS VARIABLES

| | |
|---|---|
| ff_{tgc} | Inlet flow rate of each component to g in t |
| ffTot_{tg} | Total combined inlet flow rate to g in t |
| Q_{tgg′} | Total transferred flow rate from g to g′ in t |
| P_{tgst} | Final products for g in t |
| TaskRate_{tgic} | Component rate for i in g in t |
| Rj_{tgij} | Processing rate for j performing a task i at g in t |
| ST0_{tgsc} | Inlet component rates representing raw materials states (s) for g in t |
| Rj′_{tgi} | Unified processing rate for a unit performing a task i at g in t |
| TPkW_{tgi} | Power consumption for a single j performing a task i at g in t |
| UPkW_{tgij} | Power consumption for every unit j performing a task i at g in t |
| PowerCostₜ | Power costs calculated for all running equipment according to their flow rates for t |
| ChemCostₜ | Chemicals costs calculated for all GOSPs for each t |
| FixedCostₜ | Fixed Operating Cost which is independent of the plant inlet flow rates for t |
| InstallCostₜ | Installation costs calculated for all GOSPs for t - potential equipment and swing pipelines |
| DeprCapₜ | Depreciated capital costs calculated for all GOSPs for t - potential equipment and swing pipelines |
| MaintCostₜ | Maintenance and inspection costs calculated for all GOSPs for t - potential equipment and swing pipelines |
| Total NPV | Total net present value |

Production Designation Through GOSPs

The mass balance for determining the periodic final inlet component flow rates entering the GOSPs can be expressed, as in Equation (1):

$${ff}_{tgc} = {fi}_{tgc} + ( {\sum }_{{g}^{′} ∈ {Net}_{g}} {CompFrac}_{{tcg}^{′}} * {Q}_{{tg}^{′} g} ) - ( {\sum }_{{g}^{′} ∈ {Net}_{g}}^{ } {CompFrac}_{tcg} * {Q}_{{tgg}^{′}} ) ∀ t , g , c \qquad ( 1 )$$

Transfers between GOSPs are constrained by maximum and minimum capacities of the pipelines, as expressed in Equations (2) and (3):

Q_{tgg}′≤TPCMax_{gg′}·Ytpc_{tgg}′∀t,g,g′∈Net_{g} (2)

Q_{tgg}′≥TPCMin_{gg′}·Ytpc_{tgg′}∀t,g,g′∈Net_{g} (3)

For every connection between two GOSPs, only a single direction of transfer is allowed at a time as governed by Equation (4):

Ytpc_{tgg′}+Ytpc_{tg′g}≤1; ∀t,g,g′∈Net_{g} (4)

The final inlet component flow rates for each GOSP are maintained within the potentially upgraded maximum and minimum GOSPs' capacities, as expressed in Equations (5) and (6):

ff_{tgc}≤GMax_{gc}·Ygosp_{tg}∀t,g,c (5)

and

ff_{tgc}≥GMin_{gc}·Ygosp_{tg}∀t,g,c (6),

where GMax_{gc} and GMin_{gc} are component capacities of the GOSPs, assuming all potential upgrades per GOSP are selected and installed. If no upgrades or only some upgrades are selected, then Equation (5) and (6) will maintain the final inlet component flow rates within the non-upgraded or partly upgraded component capacity of the GOSP by limiting the component rates that can be processed through the equipment. The main reason for keeping GMax_{gc} and GMin_{gc} is that sometimes the GOSP component capacity is lower than the capacity of the combined equipment capacities, due to limitation in the process control system, piping network or vessels' capacities of the GOSP.

Process Representation—Mass Balance

The STN framework was used to represent the GOSPs processes. The raw materials and the intermediate and final states are formulated, as expressed in Equations (7)-(12):

Raw Materials—STN

$$ST {0}_{tgsc} + {\sum }_{i ∈ {S}_{i}} ( {PSIcons}_{gsic} \cdot {TaskRate}_{tgic} ) = 0 ∀ t , g , c , s ∈ SR . \qquad ( 7 )$$

For Multiphase Crude:

STO_{tgsc}=ff_{tgc}∀t,g,c,s=s1 (8).

For Added Chemicals:

$${STO}_{tgsc} = \frac{{ChemA}_{g} {e}^{- {ChemB}_{g} \cdot {Temp}_{tg}}}{42} \cdot ( {ff}_{tg , oil} + {ff}_{tg , water} ) \\ ∀ t , g , c , s = s 2. \qquad ( 9 )$$

For Added Fresh Water:

STO_{tgsc}=SalF_{g}·ff_{tg,oil}∀t,g,c,s=s6 (10).

Intermediates—STN

$${\sum }_{i ∈ {S}_{i}} ( {PSIprod}_{gsic} \cdot {TaskRate}_{tgic} ) + {\sum }_{i ∈ Is} ( {PSIcons}_{gsic} \cdot {TaskRate}_{tgic} ) = 0 \\ ∀ t , g , c , s ∈ {S}^{IN} . \qquad ( 11 )$$

Final Product—STN

$${\sum }_{i ∈ {S}_{i}} ( {PSIprod}_{gsic} \cdot {TaskRate}_{tgic} ) = {P}_{tgs} \\ ∀ t , g , c , s ∈ {S}^{P} . \qquad ( 12 )$$

Equipment Allocation

The tasks' flow rates are connected to associated equipment flow rates, as expressed in Equation (13):

$${\sum }_{c} {\sum }_{s} ( {PSIprod}_{gsic} \cdot {TaskRate}_{tgic} ) = {\sum }_{j ∈ Ij} {Rj}_{tgij} \\ ∀ t , g , i ∈ IRot , \qquad ( 13 )$$

where Rj_{tgij} considers existing and potential equipment for every J∈Ij.

To keep the running equipment within operating windows, Equations (14) and (15) specify:

Rj_{tgij}≤RjMax_{gj}·Yunit_{tgij}∀t,g,i,j∈Ij (14)

and

Rj_{tgij}≥RjMin_{gj}·Yunit_{tgij}∀t,g,i,j∈Ij (15).

Linearization of Equipment Load Sharing

To ensure equal load sharing among all operating equipment for the same set and to maintain the linear model linear, Equations (16) and (17) are introduced as constraints:

Rj_{tgij}≤Rj′_{tgi}∀t,g,i and j∈Ij (16)

and

Rj_{tgij}≥Rj′_{tgi}−M1·(1−Yunit_{tgij})∀t,g,i and j∈Ij (17).

Piecewise Linearization of Single Equipment Power Consumption Per Task

Knowing the flow rates per equipment allows calculation of the consumed power linearly, as expressed in Equation (18) (which leverages Equations (19) and (20)):

$$\begin{matrix}{Rj}_{tgi}^{′} = {\sum }_{k} ( {Rjk}_{gik} \cdot {Yjk}_{tgik} ) ∀ t , g , i ∈ IRot & ( 18 ) \\ {\sum }_{k} {Yjk}_{tgik} = {Ygosp}_{tg} ∀ t , g , i ∈ IRot and & ( 19 ) \\ {TPkW}_{tgi} = {\sum }_{k} ( {Pjk}_{gik} \cdot {Yjk}_{tgik} ) ∀ t , g , i ∈ IRot , & ( 20 )\end{matrix}$$

where TPkW_{tgi} is the power consumption for a single equipment per task, keeping in mind that all running equipment in a task have equal flow rates as governed by the model.

Linearization of Equipment Power Consumption Calculation for All Running Equipment in a Task

The power for every running equipment can be calculated in a linear form, as expressed in Equations (21)-(23):

UPkW_{tgij}≤M2·Yunit_{tgij}∀t,g,i and j∈Ij (21),

UPkW_{tgij}≥TPkW_{tgi}−M2·(1−Yunit_{tgij})∀t,g,i and j∈Ij (22),

and

UPkW_{tgij}≤TPkW_{tgi}∀t,g,i and j∈Ij (23),

where UPkW_{tgij} is the power consumption for every running equipment.

Investment Decisions

There are two primary decisions to be made: 1) install a new swing pipeline between two GOSPs and 2) install additional new equipment to equipment sets to increase GOSP capacity.

Potential Swing Pipelines Investment Decisions

The new swing pipelines are already included in the above-cited Equations, which contain existing and potential swing pipelines. However, they can be utilized only if an investment takes place in a prior period. Therefore, Equations (24) and (25) are formulated to link their utilization to the swing pipelines investment binary variables as follows:

$$\begin{matrix}{\sum }_{{t}^{′}} {YtpcNEW}_{{t}^{′} {gg}^{′}} \geq ( {Ytpc}_{{tgg}^{′}} + {Ytpc}_{{tg}^{′} g} ) & ( 24 ) \\ ∀ {t}^{′} \leq t , g , {g}^{′} ∈ {NewNet}_{g} and & \\ {\sum }_{t} {YtpcNew}_{{tgg}^{′}} \leq 1 ∀ g , {g}^{′} ∈ {NewNet}_{g} , & ( 25 )\end{matrix}$$

where YtpcNEW_{tgg′} is the binary variable for the swing pipelines' investment decisions; Ytpc_{tgg′} is the binary variable that allows selecting a particular swing pipeline for transfers. NewNet_{g} is the network with all potential swing pipelines only. From the previous Equations, the new swing pipelines can only be utilized if their relative YtpcNEW_{tgg′} take a value of one in any of the preceding years.

Additional Equipment Investment Decisions

The utilization of the new equipment can only be allowed if their relative investment variable takes a value in any of the preceding years, as expressed in Equations (26) and (27):

$$\begin{matrix}{\sum }_{{t}^{′}} ( {YunitNew}_{tgij} ) \geq {Yunit}_{tgij} ∀ {t}^{′} \leq t , g , i , j ∈ {INEW}_{j} & ( 26 ) \\ and & \\ {\sum }_{{t}^{′}} ( {YunitNEW}_{tgij} ) \leq 1 ∀ g , i , j ∈ {INEW}_{j} , & ( 27 )\end{matrix}$$

where YunitNEW_{tgij} is the investment selection binary variable for potential equipment; Yunit_{tgij} is the operation selection binary variable for all equipment; INEWⱼ is the dynamic set for tasks and potential equipment.

Objective Function

Knowing whether a new equipment or swing pipeline is utilized allows calculation of a total investment cost and then input of the value in the objective function for the model to make decisions. All costs are calculated based on the NPV. Therefore, the objective function is, as expressed in Equation (28):

$$Total NPV = {\sum }_{t = 0}^{T - 1} [ \frac{\begin{matrix}{PowerCost}_{t} + {ChemCost}_{t} + {FixedCost}_{t} + \\ {InstallCost}_{t} + {DeprCap}_{t} + {MaintCost}_{t}\end{matrix}}{{( 1 + dr )}^{t}} ] , \qquad 28 )$$

where the PowerCost, ChemCost, and FixedCost are calculated for every year for all running equipment (existing and potential) in all GOSPs, as in Equations (29)-(31):

$$\begin{matrix}{PowerCost}_{t} = [ \begin{matrix}{\sum }_{g} {\sum }_{i ∈ Ic} {\sum }_{j} ( \frac{{UPkW}_{tgij}}{{MeffC}_{gj} \cdot {GBeffC}_{gj}} ) + \\ {\sum }_{g} {\sum }_{i ∈ Ip} {\sum }_{j} ( \frac{{UkW}_{tgij}}{{MeffP}_{gj}} )\end{matrix} ] \cdot OperTime \cdot KwPrice ∀ t & ( 29 ) \\ {ChemCost}_{t} = {\sum }_{g} [ {\sum }_{c} ST {0}_{tgsc} \cdot {ChemCOST}_{g} ] ∀ t , s = s 2 & ( 30 ) \\ {FixedCost}_{t} = {\sum }_{g} ( {FOC}_{g} \cdot {Ygosp}_{tg} ) ∀ t & ( 31 )\end{matrix}$$

Installation costs are only calculated for the potential equipment and pipelines if selected. Installation costs are a onetime payment paid during the investment year. Therefore, they are calculated for potential equipment and swing pipeline, as expressed in Equation (32):

$${InstallCost}_{t} = {\sum }_{g ∈ {NewNet}_{g}} {\sum }_{{g}^{′} ∈ {NewNet}_{g}} [ {YtpcNEW}_{{tgg}^{′}} \cdot {PIC}_{{gg}^{′}} ] + {\sum }_{g} {\sum }_{i} {\sum }_{j ∈ {INEW}_{j}} [ {YunitNEW}_{tgij} \cdot {EIC}_{gj} ] ∀ t . \qquad ( 32 )$$

Then, the capital costs of the potential equipment and swing pipelines are depreciated yearly only if they are used during that year. If not used, it is assuming that the capital costs are perfectly preserved in an ideal mothballed status. Similarly, the maintenance and inspection costs are considered only if the equipment are utilized in a year. Otherwise, it is assumed that the maintenance and inspection costs are maintenance free. Hence, the costs can be calculated, as in Equations (33) and (34):

$$\begin{matrix}{DeprCap}_{t} = {\sum }_{g ∈ NewNet} {\sum }_{{g}^{′} ∈ NewNet} [ {YtpcNEW}_{{tgg}^{′}} \cdot {DepPi}_{{gg}^{′}} ] + {\sum }_{g} {\sum }_{i} {\sum }_{j ∈ {INEW}_{j}} [ {YunitNEW}_{tgij} \cdot {DepEq}_{gj} ] ∀ t and & ( 33 ) \\ {MaintCost}_{t} = {\sum }_{g ∈ NewNet} {\sum }_{{g}^{′} ∈ NewNet} [ {YtpcNEW}_{{tgg}^{′}} \cdot {MaintPi}_{{gg}^{′}} ] , & ( 34 )\end{matrix}$$

where Total NPV is the total present cost; PowerCostₜ is the power costs for t; ChemCostₜ is the chemicals cost for t; FixedCostₜ is the fixed operating cost for t; InstallCostₜ is the installation cost for t; DeprCapₜ is the depreciated capital for t; MaintCostₜ is the maintenance and inspection cost for all potential equipment and swing pipelines for t.

Case Study

Two MILP solvers were used to solve an 8-year long term planning NPV optimization problem based on yearly intervals. This is based on a 10-year hypothetical long-term production forecast. The considered period is from 2017 to 2024. In this implementation, the MILP model is solved using Cplex and Gurobi solvers on two different computing machines with different processing capabilities. In other implementations, other appropriate solvers can be used. Due to the size of the problem, an optcr, a technical term used in GAMS software to define an acceptable gap between the calculated solution and the optimal solution. The optcr is used to minimize processing time, since finding a solution with low or 0% optcr (as opposed to 10% or 5%) is possible, but at the expense of CPU time. Use of a lower optcr may also result in a need to leverage a processor of higher processing capability, which will likely be more expensive. For described trial results, an optcr value of 10% was used for testing the described methodology.

Sample GAMS Solver Code

In some implementations, a sample portion of GAMS solver code used with the described methodology can include, among other things:

Note that the previously provided sample portions of GAMS solver code are provided as a representative example and to assist one of ordinary skill in the art with understanding and practice of the described concepts. The provided portions of GAMS sample code are not represented as complete, as the only way that GAMS solver code can be written or structured, or as a representation of the only values/operations that can be included in the GAMS sample code. The sample portions of GAMS solver code are also not meant to limit the disclosure in any way.

Gurobi Vs. Cplex Solvers

Table 3 illustrates long-term planning optimization MILP model statistics:

TABLE 3
Long-Term Planning Optimization MILP Model Statistics
Processor: Intel ® Xeon ® CPU W3670@3.20 GHz 3.20 GHz
General Algebraic Modelling System (GAMS) Version: 24.0.2

| | | | |
|---|---|---|---|
| Blocks of Equations | 34 | Single Equations | 33,892 |
| Blocks of Variables | 21 | Single Variables | 21,201 |
| Non Zero Elements | 91,829 | Discrete Variables | 4,064 |
| Resource Usage | 31365 | Iteration Count | 38446920 |

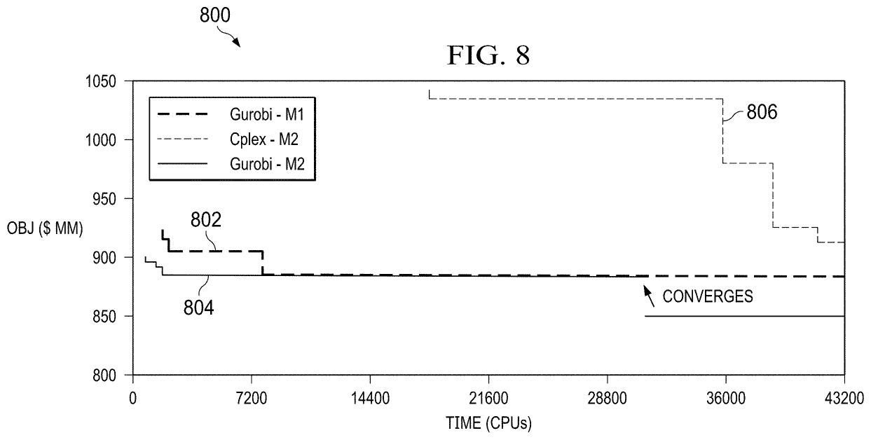

Turning to FIG. 8, FIG. 8 is a graph 800 illustrating a comparison of convergence curves between Gurobi and Cplex solvers using two different computing machines, according to an implementation of the present disclosure. In FIG. 8, the vertical axis represents millions (MM) of dollars, assuming that every M represents 1,000, and the horizontal axis represents CPU time. As can be seen in FIG. 8, the Gurobi solver 802 on a computing machine M1 exhibited a much better performance than the Cplex solver on both the M1 and an advanced processor machine (M2) and quickly found good objectives (OBJs), which are final equations of every model in mathematical optimization. Generally all other equations attempt to satisfy an objective equation. In a model, the target should be to minimize or maximize the objective based on a particular application. Using M2, the Gurobi solver 804 converged within a CPU time limit but failed to converge on M1. The Cplex solver 806 found the first intermediate solution after a relatively long time on M2, and failed to report any solution using M1 within a specified CPU limit.

Table 4 illustrates a summary of performances of both Gurobi and Cplex solvers in two different computing machines for the dynamic model.

TABLE 4
Performances of MILP Solvers for the Dynamic Model on Different
Machines

| | | GAMs | | OBJ | | |
|---|---|---|---|---|---|---|
| | Processor | Version | | ($ MM) | CPUs (s) | GAP % |
| Machine 1 | Intel ® Core ™ i5 | 24.2.1 | MILP-Cplex | Inf | 43200* | N/A |
| | CPU @ 3.2 GHz | | MILP-Gurobi | 883.29 | 43200* | 11.7 |
| | 3.19 GHz | | | | | |
| Machine 2 | Intel ® Xeon ® | 24.0.2 | MILP-Cplex | 919.94 | 43200* | 17.4 |
| | CPU | | MILP-Gurobi | 882.25 | 31365 | 10.0 |
| | W3670@3.20 GHz | | | | | |
| | 3.20 GHz | | | | | |

*Terminated by CPU time limit

MILP Model-Gurobi Solver Results

The dynamic MILP model was developed not only to optimize the NPV for the network but also to find optimum solutions to upgrade the GOSPs in response to the forecasts. By reviewing the forecasts, it is noted that the forecasted water production exceed the GOSPs capacity clearly at some years; hence, the water handling capacity of these GOSPs must be upgraded. Finding a solution by utilizing the swing pipelines network to avoid expansions is very complicated and may require a detailed review before one can be identified.

Using Gurobi solver for an optcr of 10%, the MILP model was solved for two different modes: 1) finding the optimum NPV without allowing any investments and 2) finding the optimum NPV allowing investment decisions in the model. For the first mode, the model proposed a feasible solution without any required investments. The model utilized a swing pipelines network to find complicated and integrated distributions that met a specified forecast without any required expansions, and optimized the NPV for the entire period. For the second mode, the model proposed a solution that included investment, but the investments are to further optimize the NPV and not to meet the forecast as provided by the first mode.

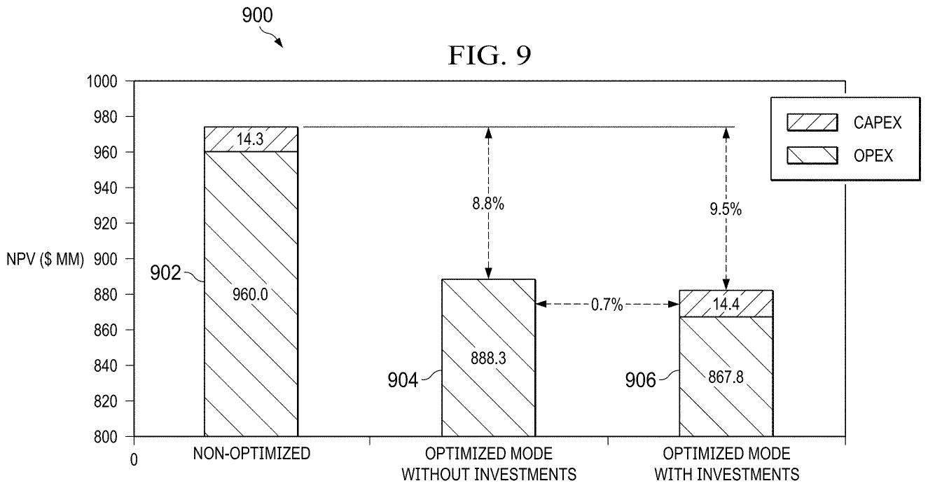

Turning to FIG. 9, FIG. 9 illustrates a comparison 900 of NPV for previously-mentioned modes associated with FIG. 8 and a non-optimized mode “current practice,” according to an implementation of the current disclosure. All associated costs with new installations are considered under CAPEX, including maintenance costs and depreciated capitals of new installations.

For the non-optimized mode 902, the obvious transfers were considered in the network to ensure fair comparison. Both optimized modes (904 and 906) offer a reduction in NPV. Cost avoidances of 8.8% ($86 MM) and 9.5% ($92 MM) are realized for the optimized modes (904 and 906) without and with investments, respectively. When comparing the optimized modes (904 and 906) with and without investments against each other, the investment-optimized mode 906 offers a lower NPV of 0.7%, which corresponds to a savings of $6 MM.

If considering that the area is mature, oil production rates are declining according to the forecast and keeping in mind uncertainties, a custodian company might be reluctant to add additional assets unless payback is significant. Therefore, the optimized mode without investments 904 may be preferred. However, if the gap can be increased to generate a desired difference, then the optimized mode with investments 906 would be preferred. In some implementations, this can be achieved by utilizing existing unrequired equipment in the same area. For example, there is additional equipment in some GOSPs that will never be utilized according to the model results and cannot be explored by the swing pipelines network. If this equipment is compatible with required new installation sites, then the investment and their associated costs can be replaced with a smaller relocation cost. Therefore, the gap will be increased and the investment-optimized mode 906 recommendations will be more desirable.

The model was applied in a very mature area where watercut has increased considerably over the years. Production started from this area since more than 50 years ago. If the model is used for a young area, referring to new fields where production has just started and field water cut is very minimal (for example, less than 10%), with an increasing forecast where several upgrading investments are compulsory, it can add a very strategic value by optimizing the required CAPEX in the same way it optimizes OPEX, as proven in this section and the real-time optimization model. Table 5 illustrates investment decisions for the optimized mode with investments (906) and non-optimized mode (902).

TABLE 5
Investment Decisions for the described optimized
mode with investments and non-optimized mode.

| | |
|---|---|
| Item | Year |

Optimized Mode with Investments

| | |
|---|---|
| 1. Injection Pump - GOSP14 | 2018 |
| 2. Injection Pump - GOSP13 | 2020 |
| 3. Swing Pipeline - (GOSP5-GOSP6) | 2020 |
| 4. Swing Pipeline - (GOSP9-GOSP12) | 2022 |

Non-Optimized Mode

| | |
|---|---|
| 1. Injection Pump - GOSP14 | 2017 |
| 2. Injection Pump - GOSP13 | 2018 |
| 3. Injection Pump - GOSP18 | 2019 |
| 4. Injection Pump - GOSP5 | 2022 |
| 5. Injection Pump - GOSP11 | 2023 |

The non-optimized mode 902 requires single-facility boundary investments in the years where the forecast exceeds the design capacity. On the other hand, the optimized mode with investments 906 demanded strategic investments for minimizing the NPV taking into consideration the forecasts and design capacities. For example, the water forecast exceeds the design capacity of 5 GOSPs at the reported years in Table 16. Rather than installing 5 injection pumps in these GOSPs, the model solved the capacity concern by utilizing the swing pipelines network and then suggested decisions to improve the total NPV. The required investments are two injection pumps in GOSP13 and GOSP14, and two swing pipelines between GOSP5-GOSP6 and GOSP9-GOSP12.

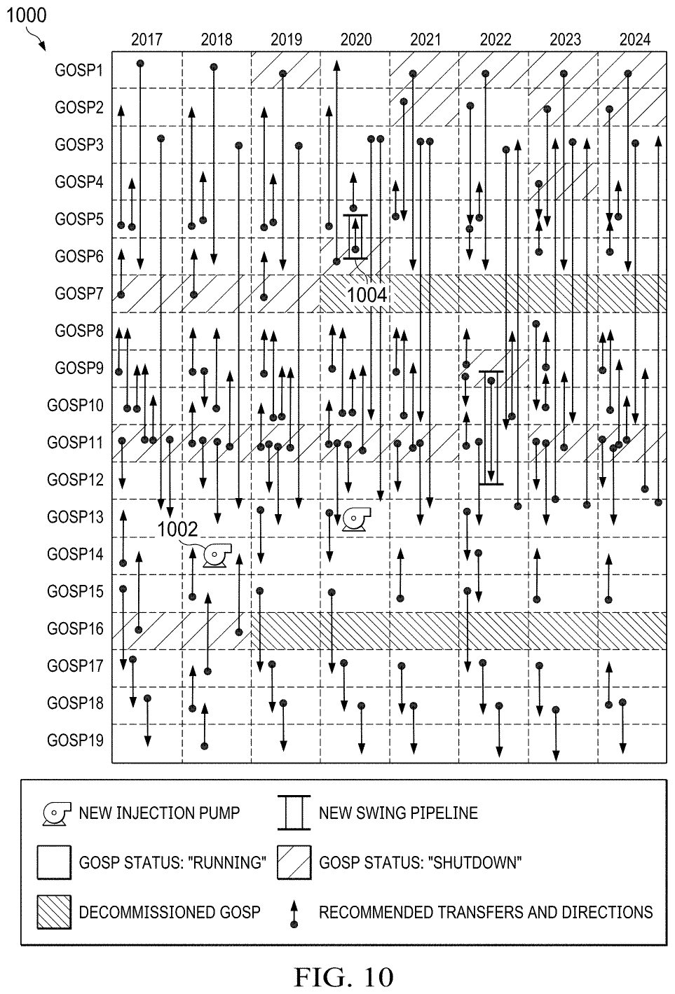

FIG. 10 is a diagram 1000 illustrating yearly transfers and investment decisions for an entire forecast period, according to an implementation of the present disclosure. By enabling a clear review of the illustrated decisions, a clear correlation can be noted between the decisions and a cost optimization. For example, the installation of an injection pump in GOSP14 in 2018 (1002) allowed the model to respond to its increase in water production and consistently transfer quantities from other GOSPs to it so that the additional capacity could be properly utilized. Another example is the installation of new swing pipeline between GOSP5-GOSP6 (1004), which allowed the shutdown of GOSP6 in 2020. Additionally, the same pipeline was utilized several times in the next few years for transfer between the two GOSPs in both directions. The same reasoning applies to the remaining two investment decisions.

Note that there are no costs associated with decommissioning GOSPs. An organization utilizes what it needs from available equipment, then offers the GOSPs under a sell-in-place bid. The bid winner contractor is responsible for decommissioning and removing all equipment in a safe and environmentally-responsible manner.

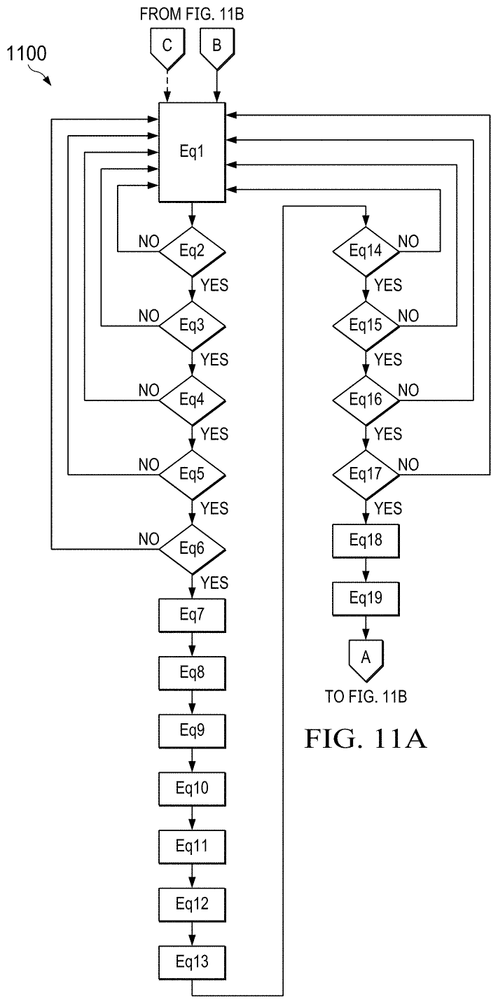

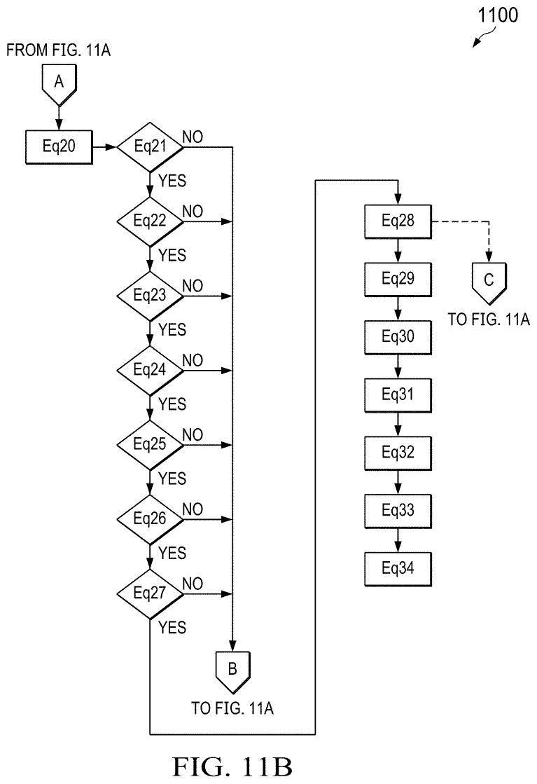

FIGS. 11A-11B represent a flowchart illustrating an example of a computer-implemented method 1100 for long-term planning for Gas Oil Separation Plants (GOSPs), according to an implementation of the present disclosure. For clarity of presentation, the description that follows generally describes method 1100 in the context of the other figures in this description. However, it will be understood that method 1100 can be performed, for example, by any system, environment, software, and hardware, or a combination of systems, environments, software, and hardware, as appropriate. In some implementations, various steps of method 1100 can be run in parallel, in combination, in loops, or in any order.

FIGS. 11A-11B illustrate one implementation of the performance of the previously-described Equations (1)-(34). Note that branching values associated with decision gates representing Equations (2)-(6), (14)-(17), and (21)-(27) are application specific and are not discussed in detail in this disclosure. For example, transfers between GOSPs are constrained by maximum and minimum capacities of the pipelines, as expressed in Equations (2) and (3). The illustrated decision gates representing Equations (2) and (3) could be configured to determine whether a result of each Equation is within a defined threshold value range, in which the determination would have a value of “Yes” and allow the method 1100 to proceed. However, if either result of Equation (2) and (3) is determined to be outside of the defined threshold value range, the determination would have a value of “No” and method 1100 would proceed back to Equation (1).

In some implementations, starting with Equation (1), a mass balance for determining periodic final inlet component flow rates entering GOSPs can be expressed. Method 1100 flows to and through Equations (2)-(6), each of which proceed to the following Equation or back to Equation (1) depending upon the resulting value generated by each Equation, as previously described. Transfers between GOSPs are constrained by maximum and minimum capacities of pipelines, as expressed in Equations (2) and (3). For every connection between two GOSPs, only a single direction of transfer is allowed at a time as governed by Equation (4). Final inlet component flow rates for each GOSP are maintained within the potentially upgraded maximum and minimum GOSPs' capacities, as expressed in Equations (5) and (6).

After Equation (6), method 1100 flows to and through Equations (7)-(13). The STN framework was used to represent the GOSPs processes. Raw materials and intermediate and final states are formulated, as expressed in Equations (7)-(12). The tasks' flow rates are connected to associated equipment flow rates, as expressed in Equation (13).

After Equation (13), method 1100 flows to and through Equations (14)-(17), each of which proceed to the following Equation or back to Equation (1) depending to upon the resulting value generated by each Equation, as previously described. Equations (14) and (15), permit keeping the running equipment within operating windows. To ensure equal load-sharing among all operating equipment for the same set and to maintain the linear model, Equations (16) and (17) are used as constraints.

After Equation (17), method 1100 flows to and through Equations (18)-(20) (as illustrated in FIG. 11B. Knowing the flow rates per equipment allows calculation of the consumed power in linear form, as expressed in Equation (18). Equation (18) leverages Equations (19) and (20).

After Equation (20), method 1100 flows to and through Equations (21)-(27), each of which proceed to the following Equation or back to Equation (1) (illustrated in FIG. 11A) depending upon the resulting value generated by each Equation, as previously described. The power for every running equipment can be calculated in a linear form, as expressed in Equations (21)-(23). Equations (24) and (25) are formulated to link utilization of existing and potential swing pipelines if an investment takes place in a prior period. Equations (26) and (27) permit utilization of the new equipment can only be allowed if their relative investment variable takes a value in any of the preceding years.

From Equation (27), method 1100 flows to Equation (28). Once a result is obtained in Equation (28), the value is recorded and method 1100 proceeds back to Equation (1) (illustrated in FIG. 11A) for a different set of variables to permit determination of an optimum solution, at which point method 1100 stops.

Note that Equations (29)-(31) are leveraged by Equation (28) to calculate PowerCost, ChemCost, and FixedCost for every year for all running equipment (existing and potential) in all GOSPs. As previously stated, installation costs are only calculated for the potential equipment and pipelines if selected. Installation costs are a onetime payment paid during the investment year. Therefore, they are calculated for potential equipment and swing pipeline, as expressed in Equation (32). The capital costs of the potential equipment and swing pipelines are depreciated yearly only if they are used during that year. If not used, it is assumed that the capital costs are perfectly preserved in an ideal mothballed status.

Similarly, the maintenance and inspection costs are considered only if the equipment are utilized in a year. Otherwise, it is assumed that the maintenance and inspection costs are maintenance free. Hence, the costs can be calculated, as in Equations (33) and (34).

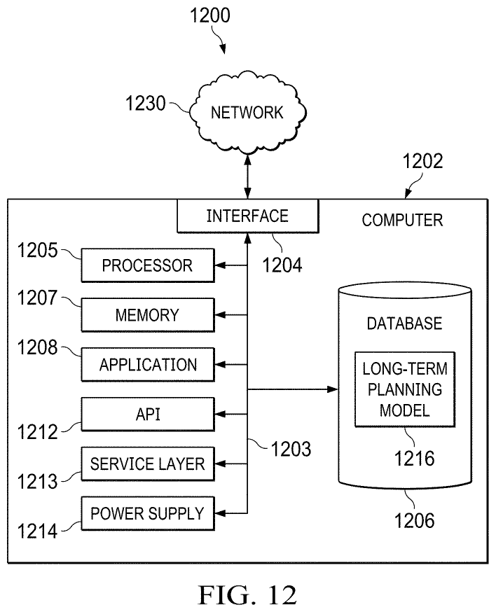

FIG. 12 is a block diagram illustrating an example of a computer-implemented System 1200 used to provide computational functionalities associated with described algorithms, methods, functions, processes, flows, and procedures, according to an implementation of the present disclosure. In the illustrated implementation, System 1200 includes a Computer 1202 and a Network 1230.

The illustrated Computer 1202 is intended to encompass any computing device such as a server, desktop computer, laptop/notebook computer, wireless data port, smart phone, personal data assistant (PDA), tablet computer, one or more processors within these devices, another computing device, or a combination of computing devices, including physical or virtual instances of the computing device, or a combination of physical or virtual instances of the computing device. Additionally, the Computer 1202 can include an input device, such as a keypad, keyboard, touch screen, another input device, or a combination of input devices that can accept user information, and an output device that conveys information associated with the operation of the Computer 1202, including digital data, visual, audio, another type of information, or a combination of types of information, on a graphical-type user interface (UI) (or GUI) or other UI. For example, in some implementations, the illustrated data (such as, in FIGS. 3, 6A-6C, and 7-10) or other GUIs (whether illustrated or not) can be interactive in nature and be configured to permit user actions to be performed (such as, triggering messages or requests for data to change, modify, or enhance the illustrated data or to perform actions based on the illustrated data).

The Computer 1202 can serve in a role in a distributed computing system as a client, network component, a server, a database or another persistency, another role, or a combination of roles for performing the subject matter described in the present disclosure. The illustrated Computer 1202 is communicably coupled with a Network 1230. In some implementations, one or more components of the Computer 1202 can be configured to operate within an environment, including cloud-computing-based, local, global, another environment, or a combination of environments.

At a high level, the Computer 1202 is an electronic computing device operable to receive, transmit, process, store, or manage data and information associated with the described subject matter. According to some implementations, the Computer 1202 can also include or be communicably coupled with a server, including an application server, e-mail server, web server, caching server, streaming data server, another server, or a combination of servers.

The Computer 1202 can receive requests over Network 1230 (for example, from a client software application executing on another Computer 1202) and respond to the received requests by processing the received requests using a software application or a combination of software applications. In addition, requests can also be sent to the Computer 1202 from internal users (for example, from a command console or by another internal access method), external or third-parties, or other entities, individuals, systems, or computers.

Each of the components of the Computer 1202 can communicate using a System Bus 1203. In some implementations, any or all of the components of the Computer 1202, including hardware, software, or a combination of hardware and software, can interface over the System Bus 1203 using an application programming interface (API) 1212, a Service Layer 1213, or a combination of the API 1212 and Service Layer 1213. The API 1212 can include specifications for routines, data structures, and object classes. The API 1212 can be either computer-language independent or dependent and refer to a complete interface, a single function, or even a set of APIs. The Service Layer 1213 provides software services to the Computer 1202 or other components (whether illustrated or not) that are communicably coupled to the Computer 1202. The functionality of the Computer 1202 can be accessible for all service consumers using the Service Layer 1213. Software services, such as those provided by the Service Layer 1213, provide reusable, defined functionalities through a defined interface. For example, the interface can be software written in JAVA, C++, another computing language, or a combination of computing languages providing data in extensible markup language (XML) format, another format, or a combination of formats. While illustrated as an integrated component of the Computer 1202, alternative implementations can illustrate the API 1212 or the Service Layer 1213 as stand-alone components in relation to other components of the Computer 1202 or other components (whether illustrated or not) that are communicably coupled to the Computer 1202. Moreover, any or all parts of the API 1212 or the Service Layer 1213 can be implemented as a child or a sub-module of another software module, enterprise application, or hardware module without departing from the scope of the present disclosure.

The Computer 1202 includes an Interface 1204. Although illustrated as a single Interface 1204, two or more Interfaces 1204 can be used according to particular needs, desires, or particular implementations of the Computer 1202. The Interface 1204 is used by the Computer 1202 for communicating with another computing system (whether illustrated or not) that is communicatively linked to the Network 1230 in a distributed environment. Generally, the Interface 1204 is operable to communicate with the Network 1230 and includes logic encoded in software, hardware, or a combination of software and hardware. More specifically, the Interface 1204 can include software supporting one or more communication protocols associated with communications such that the Network 1230 or hardware of Interface 1204 is operable to communicate physical signals within and outside of the illustrated Computer 1202.

The Computer 1202 includes a Processor 1205. Although illustrated as a single Processor 1205, two or more Processors 1205 can be used according to particular needs, desires, or particular implementations of the Computer 1202. Generally, the Processor 1205 executes instructions and manipulates data to perform the operations of the Computer 1202 and any algorithms, methods, functions, processes, flows, and procedures as described in the present disclosure.

The Computer 1202 also includes a Database 1206 that can hold data for the Computer 1202, another component communicatively linked to the Network 1230 (whether illustrated or not), or a combination of the Computer 1202 and another component. For example, Database 1206 can be an in-memory, conventional, or another type of database storing data consistent with the present disclosure. In some implementations, Database 1206 can be a combination of two or more different database types (for example, a hybrid in-memory and conventional database) according to particular needs, desires, or particular implementations of the Computer 1202 and the described functionality. Although illustrated as a single Database 1206, two or more databases of similar or differing types can be used according to particular needs, desires, or particular implementations of the Computer 1202 and the described functionality. While Database 1206 is illustrated as an integral component of the Computer 1202, in alternative implementations, Database 1206 can be external to the Computer 1202. As illustrated, the Database 1206 holds the previously described long-term planning model 1216.

The Computer 1202 also includes a Memory 1207 that can hold data for the Computer 1202, another component or components communicatively linked to the Network 1230 (whether illustrated or not), or a combination of the Computer 1202 and another component. Memory 1207 can store any data consistent with the present disclosure. In some implementations, Memory 1207 can be a combination of two or more different types of memory (for example, a combination of semiconductor and magnetic storage) according to particular needs, desires, or particular implementations of the Computer 1202 and the described functionality. Although illustrated as a single Memory 1207, two or more Memories 1207 or similar or differing types can be used according to particular needs, desires, or particular implementations of the Computer 1202 and the described functionality. While Memory 1207 is illustrated as an integral component of the Computer 1202, in alternative implementations, Memory 1207 can be external to the Computer 1202.

The Application 1208 is an algorithmic software engine providing functionality according to particular needs, desires, or particular implementations of the Computer 1202, particularly with respect to functionality described in the present disclosure. For example, Application 1208 can serve as one or more components, modules, or applications. Further, although illustrated as a single Application 1208, the Application 1208 can be implemented as multiple Applications 1208 on the Computer 1202. In addition, although illustrated as integral to the Computer 1202, in alternative implementations, the Application 1208 can be external to the Computer 1202.

The Computer 1202 can also include a Power Supply 1214. The Power Supply 1214 can include a rechargeable or non-rechargeable battery that can be configured to be either user- or non-user-replaceable. In some implementations, the Power Supply 1214 can include power-conversion or management circuits (including recharging, standby, or another power management functionality). In some implementations, the Power Supply 1214 can include a power plug to allow the Computer 1202 to be plugged into a wall socket or another power source to, for example, power the Computer 1202 or recharge a rechargeable battery.

There can be any number of Computers 1202 associated with, or external to, a computer system containing Computer 1202, each Computer 1202 communicating over Network 1230. Further, the term “client,” “user,” or other appropriate terminology can be used interchangeably, as appropriate, without departing from the scope of the present disclosure. Moreover, the present disclosure contemplates that many users can use one Computer 1202, or that one user can use multiple computers 1202.

In some implementations, the described methodology can be configured to send messages, instructions, or other communications to a computer-implemented controller, database, or other computer-implemented system to dynamically initiate control of, control, or cause another computer-implemented system to perform a computer-implemented or other function/operation. For example, operations based on data, operations, outputs, or interaction with a GUI can be transmitted to cause operations associated with a computer, database, network, or other computer-based system to perform storage efficiency, data retrieval, or other operations consistent with this disclosure. In another example, interacting with any illustrated GUI can automatically result in one or more instructions transmitted from the GUI to trigger requests for data, storage of data, analysis of data, or other operations consistent with this disclosure.

In some instances, transmitted instructions can result in control, operation, modification, enhancement, or other operations with respect to a tangible, real-world piece of computing or other equipment. For example, the described GUIs can send a request to slow or speed up a computer database, magnetic/optical disk drive, activate/deactivate a computing system, cause a network interface device to become enabled/disabled, throttled, to increase data bandwidth allowed across a network connection, or to sound an audible/visual alarm (such as, a mechanical alarm/light emitting device) as a notification of a result, behavior, determination, or analysis with respect to a computing system(s) associated with the described methodology or interacting with the computing system(s) associated with the described methodology.

In some implementations, the output of the described methodology can be used to dynamically influence, direct, control, influence, or manage tangible, real-world equipment related to hydrocarbon production, analysis, and recovery or for other purposes consistent with this disclosure. For example, data relating to the described long-term planning model or any other data described in this disclosure can be used in other analytical/predictive processes. As another example, the data relating to the described long-term planning model or any other data described in this disclosure can be used to modify a wellbore trajectory, increase/decrease speed of or stop/start a hydrocarbon drill; activate/deactivate an alarm (such as, a visual, auditory, or voice alarm), or to affect one or more GOSPs, refinery, or pumping operations (for example, stop, restart, accelerate, or reduce). Other examples can include alerting geo-steering and directional drilling staff when underground obstacles have been detected (such as, with a visual, auditory, or voice alarm). In some implementations, the described methodology can be integrated as part of a dynamic computer-implemented control system to control, influence, or use with any hydrocarbon-related or other tangible, real-world equipment explicitly mentioned in or consistent with this disclosure.

Described implementations of the subject matter can include one or more features, alone or in combination.

For example, in a first implementation, a computer-implemented method, comprising: determining a mass balance for periodic final inlet component flow rates entering Gas Oil Separation Plants (GOSPs); for transfers between GOSPs, calculating constraints based on capacities of pipelines and a single direction of transfer; maintaining calculated final inlet component flow rates for each GOSP within the calculated maximum and minimum GOSP pipeline capacities; formulating raw materials and intermediate and final states; calculating, in linear form, consumed power using known flow rates per equipment; performing investment decisions with respect to swing pipelines and new equipment; and calculating a final net present value (NPV) with an overall objective function.

The foregoing and other described implementations can each, optionally, include one or more of the following features:

A first feature, combinable with any of the following features, wherein GOSP processes are represented by a state task network (STN).

A second feature, combinable with any of the previous or following features, wherein, for formulating raw materials and intermediate final states, task flow rates are associated with equipment flow rates.

A third feature, combinable with any of the previous or following features, further comprising calculating constraints for keeping the running equipment within operating windows and to ensure equal load-sharing among all operating equipment for the same set and to maintain a linear model.

A fourth feature, combinable with any of the previous or following features, wherein investment decisions with respect to swing pipelines and new equipment include: 1) installation of a new swing pipeline between two GOSPs and 2) installation of additional new equipment to equipment sets to increase GOSP capacity.

A fifth feature, combinable with any of the previous or following features, wherein the result of the performed investment decisions input into the overall objective function.

A sixth feature, combinable with any of the previous or following features, wherein the calculation of the NPV includes power cost, chemical cost, fixed cost, installation cost, depreciated capital, and maintenance cost.

In a second implementation, a non-transitory, computer-readable medium storing one or more instructions executable by a computer system to perform operations comprising: determining a mass balance for periodic final inlet component flow rates entering Gas Oil Separation Plants (GOSPs); for transfers between GOSPs, calculating constraints based on capacities of pipelines and a single direction of transfer; maintaining calculated final inlet component flow rates for each GOSP within the calculated maximum and minimum GOSP pipeline capacities; formulating raw materials and intermediate and final states; calculating, in linear form, consumed power using known flow rates per equipment; performing investment decisions with respect to swing pipelines and new equipment; and calculating a final net present value (NPV) with an overall objective function.

The foregoing and other described implementations can each, optionally, include one or more of the following features:

A first feature, combinable with any of the following features, wherein GOSP processes are represented by a state task network (STN).

A second feature, combinable with any of the previous or following features, wherein, for formulating raw materials and intermediate final states, task flow rates are associated with equipment flow rates.

A third feature, combinable with any of the previous or following features, further comprising one or more instructions to calculate constraints for keeping the running equipment within operating windows and to ensure equal load-sharing among all operating equipment for the same set and to maintain a linear model.

A fourth feature, combinable with any of the previous or following features, wherein investment decisions with respect to swing pipelines and new equipment include: 1) installation of a new swing pipeline between two GOSPs and 2) installation of additional new equipment to equipment sets to increase GOSP capacity.

A fifth feature, combinable with any of the previous or following features, wherein the result of the performed investment decisions input into the overall objective function.

A sixth feature, combinable with any of the previous or following features, wherein the calculation of the NPV includes power cost, chemical cost, fixed cost, installation cost, depreciated capital, and maintenance cost.

In a third implementation, a computer-implemented system, comprising: one or more computers; and one or more computer memory devices interoperably coupled with the one or more computers and having tangible, non-transitory, machine-readable media storing one or more instructions that, when executed by the one or more computers, perform one or more operations comprising: determining a mass balance for periodic final inlet component flow rates entering Gas Oil Separation Plants (GOSPs); for transfers between GOSPs, calculating constraints based on capacities of pipelines and a single direction of transfer; maintaining calculated final inlet component flow rates for each GOSP within the calculated maximum and minimum GOSP pipeline capacities; formulating raw materials and intermediate and final states; calculating, in linear form, consumed power using known flow rates per equipment; performing investment decisions with respect to swing pipelines and new equipment; and calculating a final net present value (NPV) with an overall objective function.

The foregoing and other described implementations can each, optionally, include one or more of the following features:

A first feature, combinable with any of the following features, wherein GOSP processes are represented by a state task network (STN).

A second feature, combinable with any of the previous or following features, wherein, for formulating raw materials and intermediate final states, task flow rates are associated with equipment flow rates.

A third feature, combinable with any of the previous or following features, further comprising one or more instructions to calculate constraints for keeping the running equipment within operating windows and to ensure equal load-sharing among all operating equipment for the same set and to maintain a linear model.

A fourth feature, combinable with any of the previous or following features, wherein investment decisions with respect to swing pipelines and new equipment include: 1) installation of a new swing pipeline between two GOSPs and 2) installation of additional new equipment to equipment sets to increase GOSP capacity.

A fifth feature, combinable with any of the previous or following features, wherein the result of the performed investment decisions input into the overall objective function.

A sixth feature, combinable with any of the previous or following features, wherein the calculation of the NPV includes power cost, chemical cost, fixed cost, installation cost, depreciated capital, and maintenance cost.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special purpose logic circuitry, for example, a central processing unit (CPU), a field programmable gate array (FPGA), or an application-specific integrated circuit (ASIC). In some implementations, the computer or computer-implemented system or special purpose logic circuitry (or a combination of the computer or computer-implemented system and special purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system of some type, for example LINUX, UNIX, WINDOWS, MAC OS, ANDROID, IOS, another operating system, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special purpose logic circuitry, for example, a CPU, an FPGA, or an ASIC.

Computers for the execution of a computer program can be based on general or special purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity, a multi-touch screen using capacitive or electric sensing, or another type of touchscreen. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
determining a mass balance for periodic final inlet component flow rates entering Gas Oil Separation Plants (GOSPs);
for transfers between GOSPs, calculating constraints based on capacities of pipelines and a single direction of transfer;
maintaining calculated final inlet component flow rates for each GOSP within the calculated maximum and minimum GOSP pipeline capacities;
formulating raw materials and intermediate and final states;
calculating, in linear form, consumed power using known flow rates per equipment;
performing investment decisions with respect to swing pipelines and new equipment; and
calculating a final net present value (NPV) with an overall objective function.

2. The computer-implemented method of claim 1, wherein GOSP processes are represented by a state task network (STN).

3. The computer-implemented method of claim 1, wherein, for formulating raw materials and intermediate final states, task flow rates are associated with equipment flow rates.

4. The computer-implemented method of claim 1, further comprising calculating constraints for keeping the running equipment within operating windows and to ensure equal load-sharing among all operating equipment for the same set and to maintain a linear model.

5. The computer-implemented method of claim 1, wherein investment decisions with respect to swing pipelines and new equipment include: 1) installation of a new swing pipeline between two GOSPs and 2) installation of additional new equipment to equipment sets to increase GOSP capacity.

6. The computer-implemented method of claim 1, wherein the result of the performed investment decisions input into the overall objective function.

7. The computer-implemented method of claim 1, wherein the calculation of the NPV includes power cost, chemical cost, fixed cost, installation cost, depreciated capital, and maintenance cost.

8. A non-transitory, computer-readable medium storing one or more instructions executable by a computer system to perform operations comprising:
determining a mass balance for periodic final inlet component flow rates entering Gas Oil Separation Plants (GOSPs);
for transfers between GOSPs, calculating constraints based on capacities of pipelines and a single direction of transfer;
to maintaining calculated final inlet component flow rates for each GOSP within the calculated maximum and minimum GOSP pipeline capacities;
formulating raw materials and intermediate and final states;
calculating, in linear form, consumed power using known flow rates per equipment;
is performing investment decisions with respect to swing pipelines and new equipment; and
calculating a final net present value (NPV) with an overall objective function.

9. The non-transitory, computer-readable medium of claim 8, wherein GOSP processes are represented by a state task network (STN).

10. The non-transitory, computer-readable medium of claim 8, wherein, for formulating raw materials and intermediate final states, task flow rates are associated with equipment flow rates.

11. The non-transitory, computer-readable medium of claim 8, further comprising one or more instructions to calculate constraints for keeping the running equipment within operating windows and to ensure equal load-sharing among all operating equipment for the same set and to maintain a linear model.

12. The non-transitory, computer-readable medium of claim 8, wherein investment decisions with respect to swing pipelines and new equipment include: 1) installation of a new swing pipeline between two GOSPs and 2) installation of additional new equipment to equipment sets to increase GOSP capacity.

13. The non-transitory, computer-readable medium of claim 8, wherein the result of the performed investment decisions input into the overall objective function.

14. The non-transitory, computer-readable medium of claim 8, wherein the calculation of the NPV includes power cost, chemical cost, fixed cost, installation cost, depreciated capital, and maintenance cost.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
determining a mass balance for periodic final inlet component flow rates entering Gas Oil Separation Plants (GOSPs);
for transfers between GOSPs, calculating constraints based on capacities of pipelines and a single direction of transfer;
maintaining calculated final inlet component flow rates for each GOSP within the calculated maximum and minimum GOSP pipeline capacities;
formulating raw materials and intermediate and final states;
calculating, in linear form, consumed power using known flow rates per equipment;
performing investment decisions with respect to swing pipelines and new equipment; and
calculating a final net present value (NPV) with an overall objective function.

16. The computer-implemented system of claim 15, wherein GOSP processes are represented by a state task network (STN).

17. The computer-implemented system of claim 15, wherein, for formulating raw materials and intermediate final states, task flow rates are associated with equipment flow rates.

18. The computer-implemented system of claim 15, further comprising one or more instructions to calculate constraints for keeping the running equipment within operating windows and to ensure equal load-sharing among all operating equipment for the same set and to maintain a linear model.

19. The computer-implemented system of claim 15, wherein investment decisions with respect to swing pipelines and new equipment include: 1) installation of a new swing pipeline between two GOSPs and 2) installation of additional new equipment to equipment sets to increase GOSP capacity.

20. The computer-implemented system of claim 15, wherein the result of the performed investment decisions input into the overall objective function, and wherein the calculation of the NPV includes power cost, chemical cost, fixed cost, installation cost, depreciated capital, and maintenance cost.
